(19) United States
(12) Patent Application Publication
(10) Pub. No.: US 2026/0241282 A1
(43) Pub. Date: Aug. 20, 2026

(54) Virtual Equipment Recommendation Methods and Apparatuses, Device, Medium and Product

(71) Applicant: Tencent Technology (Shenzhen) Company Limited, Shenzhen (CN)

(72) Inventors: Mutian Shi, Shenzhen (CN); Peicheng Liu, Shenzhen (CN)

(21) Appl. No.: 19/643,019

(22) Filed: Apr. 9, 2026

Related U.S. Application Data
(63) Continuation of application No. PCT/CN2025/077817, filed on Feb. 18, 2025.

(30) Foreign Application Priority Data
Feb. 23, 2024 (CN) 2024102115145

(51) Int. Cl. A63F 13/533; A63F 13/52; A63F 13/79; A63F 13/87

(52) U.S. Cl. CPC A63F 13/533; A63F 13/52; A63F 13/79; A63F 13/87

(57) ABSTRACT

Virtual equipment selection and recommendation in a virtual environment is disclosed in this application. A method comprises: displaying an equipment configuration interface; in response to receiving an equipment recommendation request, sending an equipment assistant request to a second account; and displaying equipment recommendation information fed back by the second account.

### RELATED APPLICATIONS

This application is a Continuation of PCT Application No. PCT/CN2025/077817, filed February 18, 2025, which claims priority to China Patent Application No. 202410211514.5, filed with the China National Intellectual Property Administration on February 23, 2024, each entitled "VIRTUAL EQUIPMENT RECOMMENDATION METHODS AND APPARATUSES, DEVICE, MEDIUM AND PRODUCT", and each of which is incorporated herein by reference in its entirety.

### FIELD OF THE TECHNOLOGY

This application relates to the field of computer technologies, and in particular, to virtual equipment recommendation methods and apparatuses, a device, a medium, and a product.

### BACKGROUND OF THE DISCLOSURE

In some game scenes, a player may exchange for virtual equipment from a game store before participating in a virtual battle. The virtual equipment can decorate a player character and assist the player in performing the virtual battle. For a novice player, proper selection of virtual equipment can increase a win rate when there is less battle experience.

In the related technology, a game store includes a plurality of candidate equipment, and a player can select a needed virtual equipment from the plurality of candidate equipment.

However, when selecting the virtual equipment, novice players may need a long time to decide, resulting in low efficiency of human computer interaction.

### SUMMARY

This application provides virtual equipment recommendation methods and apparatuses, a device, a medium, and a product, which can assist a player in selecting one or more virtual equipment, thereby improving human-computer interaction efficiency. Technical solutions are as follows:

According to an aspect, a virtual equipment recommendation method is provided. The method is performed by a computer device, and the method comprises: displaying an equipment configuration interface, the equipment configuration interface being configured for configuring a virtual equipment for a first virtual character controlled by a first account, and the equipment configuration interface including a plurality of pieces of candidate equipment; transmitting an equipment assistance request to a second account in response to receiving an equipment recommendation request, the equipment assistance request being configured for requesting the second account to provide equipment recommendation information of the first virtual character to the first account; and displaying the equipment recommendation information fed back by the second account, the equipment recommendation information including a candidate equipment recommended by the second account to the first account.

According to another aspect, a virtual equipment recommendation method is provided. The method is performed by a computer device, and the method comprises: receiving and displaying an equipment assistance request transmitted by a first account, the equipment assistance request being configured for requesting a second account to provide equipment recommendation information of a first virtual character to the first account, the first virtual character being a virtual character controlled by the first account, and the equipment recommendation information being configured for indicating the first account to configure a virtual equipment for the first virtual character; displaying an equipment configuration interface, the equipment configuration interface including a plurality of pieces of candidate equipment; and sending (e.g., feeding back) the equipment recommendation information to the first account in response to receiving an equipment recommendation instruction for the equipment configuration interface, the equipment recommendation information including a candidate equipment recommended by the second account to the first account.

According to another aspect, a virtual equipment recommendation apparatus is provided, and the apparatus includes: a display module, configured to display an equipment configuration interface, the equipment configuration interface being configured for configuring a virtual equipment for a first virtual character controlled by a first account, and the equipment configuration interface including a plurality of pieces of candidate equipment; and a transmission module, configured to transmit an equipment assistance request to a second account in response to receiving an equipment recommendation request, the equipment assistance request being configured for requesting the second account to provide equipment recommendation information of the first virtual character to the first account; the display module being further configured to display the equipment recommendation information fed back by the second account, the equipment recommendation information including a candidate equipment recommended by the second account to the first account.

According to another aspect, a virtual equipment recommendation apparatus is provided, and the apparatus comprises: a receiving module, configured to receive and display an equipment assistance request transmitted by a first account, the equipment assistance request being configured for requesting a second account to provide equipment recommendation information of a first virtual character to the first account, the first virtual character being a virtual character controlled by the first account, and the equipment recommendation information being configured for indicating the first account to configure a virtual equipment for the first virtual character; a display module, configured to display an equipment configuration interface, the equipment configuration interface including a plurality of pieces of candidate equipment; and a feedback module, configured to feed back the equipment recommendation information to the first account in response to receiving an equipment recommendation instruction for the equipment configuration interface, the equipment recommendation information including a candidate equipment recommended by the second account to the first account.

According to another aspect, a computer device is provided. The computer device includes a processor and a memory, the memory having at least one instruction, at least one program, a code set or an instruction set stored therein, the at least one instruction, the at least one program, the code set or the instruction set being loaded and executed by the processor to implement the virtual equipment recommendation method according to any one of the foregoing examples of this application.

According to another aspect, a computer-readable storage medium is provided, having at least one instruction, at least one segment of program, a code set, or an instruction set stored therein, the at least one instruction, the at least one segment of program, the code set, or the instruction set being loaded and executed by a processor to implement the virtual equipment recommendation method according to any one of the foregoing examples of this application.

According to another aspect, a computer program product or a computer program is provided, the computer program product or the computer program including computer instructions, the computer instructions being stored in a computer-readable storage medium. A processor of a computer device reads the computer instructions from the computer-readable storage medium, and the processor executes the computer instructions, to cause the computer device to perform the virtual equipment recommendation method according to any one of the foregoing examples.

The technical solutions provided in the examples of this application have at least the following beneficial effects:

When a virtual equipment is configured for a first virtual character, equipment help seeking information (e.g., an equipment assistance request) is sent to a second account by using an equipment recommendation request, to instruct, by using the second account, how to equip the virtual equipment. Equipment recommendation information fed back by the second account based on the equipment help seeking information is displayed, so that an equipment recommended by the second account to the first account can be intuitively presented, and a player of the first account can be assisted in selecting the to-be-equipped virtual equipment. In this way, decision-making time of the player is reduced, efficiency of configuring the virtual equipment by the player and human-computer interaction efficiency are improved. In addition, a battle process of a game battle can be accelerated, thereby reducing power consumption when a device is supporting the game battle.

### BRIEF DESCRIPTION OF THE DRAWINGS

FIG. 1 is a schematic diagram of an interaction process in which a first account requests equipment recommendation information from a second account according to an example of this application.

FIG. 2 is a structural block diagram of an electronic device according to an example of this application.

FIG. 3 is a block diagram of a computer system according to an example of this application.

FIG. 4 is a flowchart of a virtual equipment recommendation method according to an example of this application.

FIG. 5 is a schematic diagram of an equipment configuration interface according to an example of this application.

FIG. 6 is a schematic diagram of triggering an equipment help seeking control according to an example of this application.

FIG. 7 is a schematic diagram of receiving and displaying equipment recommendation information by a first account according to an example of this application.

FIG. 8 is a schematic diagram of displaying help seeking progress information according to an example of this application.

FIG. 9 is a schematic diagram of ending an equipment recommendation procedure according to an example of this application.

FIG. 10 is a flowchart of a virtual equipment recommendation method according to another example of this application.

FIG. 11 is a flowchart of a virtual equipment recommendation method based on a comparison result according to an example of this application.

FIG. 12 is a flowchart of a method in which a second account recommends a virtual equipment to a first account according to an example of this application.

FIG. 13 is a schematic diagram of displaying equipment help seeking information according to an example of this application.

FIG. 14 is a schematic diagram of displaying an equipment configuration interface on a terminal of a second account according to an example of this application.

FIG. 15 is a schematic diagram of feeding back equipment recommendation information to a first account according to an example of this application.

FIG. 16 is a structural block diagram of a virtual equipment recommendation apparatus according to an example of this application.

FIG. 17 is a structural block diagram of a virtual equipment recommendation apparatus according to another example of this application.

FIG. 18 is a structural block diagram of a virtual equipment recommendation apparatus according to still another example of this application.

FIG. 19 is a structural block diagram of a computer device according to an example of this application.

### DETAILED DESCRIPTION

First, terms described in examples of this application are briefly introduced.

Virtual character/virtual object: The virtual character/virtual object is a movable object in a virtual scene. The movable object may be a virtual character, a virtual animal, a cartoon character, or the like, for example, a character, an animal, a plant, an oil drum, a wall, or a stone displayed in the three-dimensional virtual scene. In some examples, the virtual object is a three-dimensional spatial model created based on a skeletal animation technology. Each virtual object has a shape and a volume in the three-dimensional virtual scene, and occupies some space in the three-dimensional virtual scene.

Virtual scene: The virtual scene is displayed (or provided) when an application program is run on a terminal. The virtual scene may be a simulated scene of a real scene, may be a semi-simulated and semi-fictional scene, or may be a completely fictional scene. The virtual scene may be any one of a two-dimensional virtual scene, a 2.5-dimensional virtual scene, or a three-dimensional virtual scene. This is not limited in this application. Descriptions are made by using an example in which the virtual scene is a three-dimensional virtual scene in the following examples.

Multi-player online battle arena: The multi-player online battle arena means that different virtual teams belonging to at least two different enemy camps occupy respective map regions, and compete with specific victory conditions as goals. The victory conditions include, but are not limited to: at least one of occupying a stronghold or destroying a stronghold of an enemy camp, defeating a virtual character in an enemy camp, ensuring survival in a specified scene and time, seizing a specific resource, and outscoring an opponent within a specified time. Tactical competition may be performed by using a round as a unit, and maps of rounds of tactical competition may be the same or may be different. Each virtual team includes one or more virtual characters, for example, 1, 2, 3, or 5.

"In response to" is configured for representing a condition or a status on which an executed operation depends, and when a dependent condition or status is met, one or more executed operations may be in real time or may have a set delay. There is no limitation on a sequence in which operations are performed without particular description.

Virtual equipment: The virtual equipment refers to, for example, virtual clothes or virtual props, worn by a virtual character. For example, the virtual clothes include a virtual boot, a virtual armor, a virtual helmet, a virtual bracelet, a virtual belt, and the like, and the virtual props include a virtual medicine, a virtual arrow, a virtual medical kit, a virtual wand, and the like. The virtual equipment may have a function attribute. For example, a virtual armor worn by a virtual character can reduce a damage value from an enemy party. For another example, a virtual wand equipped by a virtual character can cast a spell skill to attack an enemy virtual character. For another example, a virtual medical kit of a virtual character can provide a healing service to a friendly virtual character. While “equipment” is typically an uncountable noun, this application, in some instances, uses “equipments” to indicate multiple pieces of equipment and “equipment” to indicate one piece of equipment.

In some virtual-scene-based applications or game applications, a player may control a virtual character to perform an activity and execute a task or a specified action, for example, make virtual characters perform a virtual battle with each other.

Before the virtual character participates in the virtual battle, the player may configure virtual equipments for the virtual character, and the virtual equipments may be obtained through exchange by using a particular quantity of exchange resources in an exchange store provided by a game system. The virtual equipment can provide an equipment effect to the virtual character, for example, decorating the virtual character, increasing a win rate of the virtual character in the virtual battle, reducing damage to the virtual character in the virtual battle, or increasing a speed of the virtual character during movement.

This application provides a virtual equipment recommendation method, so that when selecting virtual equipments, a player initiates help seeking to other players, and the other players provide equipment recommendation information for the player, thereby reducing decision-making time of the player, and improving human-computer interaction efficiency.

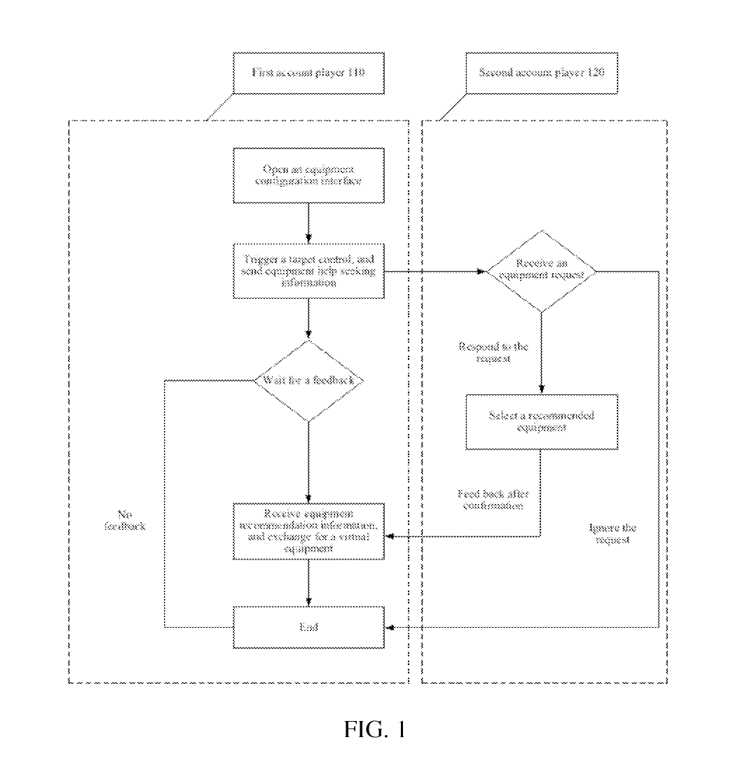

As shown in FIG. 1 below, FIG. 1 is a schematic diagram of an interaction process in which a first account requests equipment recommendation information from a second account.

A first account player 110 initiates help seeking to a second account player 120, and the second account player 120 recommends an equipment to the first account player 110 after receiving the help seeking.

First, the first account player 110 opens an equipment configuration interface, the equipment configuration interface presents a plurality of candidate equipments (e.g., a plurality of pieces of equipment), the equipment configuration interface further includes a target control, and the target control is configured for sending equipment help seeking information to the second account player 120. After triggering the target control, the first account player 110 sends the equipment help seeking information to the second account player 120.

In this case, the first account player 110 waits for a feedback of the second account player 120, and after receiving an equipment recommendation request, the second account player 120 may choose to respond to the request, or may choose to ignore the request.

If responding to the request, the second account player 120 selects a set of virtual equipments for the first account player 110 on the equipment configuration interface, and feeds back the equipment recommendation information to the first account player 110. After receiving the equipment recommendation information, the first account player 110 may select to exchange for the virtual equipments recommended by the second account player 120.

If the second account player 120 ignores the request, this interaction ends. The first account player 110 does not receive the equipment recommendation information, and this interaction ends when a waiting duration reaches a preset threshold.

In some examples, the first account player may alternatively simultaneously seek help from a plurality of account players. For example, the first account has three teammate accounts in a virtual battle, which are respectively a second account, a third account, and a fourth account, and equipment help seeking information may be simultaneously sent to the three accounts. Each teammate account not only may choose to recommend virtual equipments to the first account, but also may choose to ignore the equipment help seeking information. When a plurality of accounts respond to the equipment help seeking information, if the second account is an account that first feeds back equipment recommendation information to the first account, regardless of whether the third account and the fourth account feed back equipment recommendation information to the first account, the equipment recommendation procedure ends.

According to the method provided in this application, a player can seek help from another player when making a decision about virtual equipments, and a player with certain experience selects suitable virtual equipments for the player, thereby efficiently selecting virtual equipments, reducing decision time, and improving human-computer interaction efficiency. In addition, a battle process of a game battle can be accelerated, thereby reducing power consumption when a device is supporting the game battle. Meanwhile, interaction between players can be promoted, communication costs between teammate players are reduced, a win rate of a virtual battle of the players is increased to some extent, and game experience of the players is improved.

A terminal in this application may be a desktop computer, a portable laptop computer, a mobile phone, a tablet computer, an e-book reader, a moving picture experts group audio layer III (MP3) player, a moving picture experts group audio layer IV (MP4) player, or the like. An application supporting a virtual scene, for example, an application supporting a three-dimensional virtual scene, is installed and run on the terminal. The application program may be any one of a virtual reality application program, a three-dimensional map program, a simulation game (SLG), a third-person shooter (TPS) game, a first-person shooter (FPS) game, a multi-player online battle arena (MOBA) game, a casual party game, a tower defense game, a community game, or the like. In some examples, the application may be a console application, for example, a console three-dimensional game program, or may be a network-connected application.

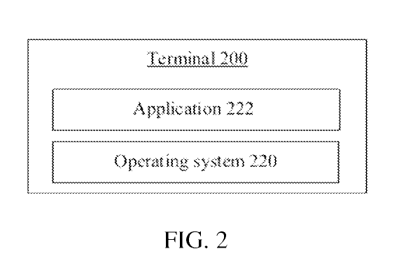

FIG. 2 is a structural block diagram of an electronic device according to an example of this application. The electronic device 200 includes an operating system 220 and an application 222.

The operating system 220 is basic software provided for the application 222 to perform secure access to computer hardware.

The application 222 is an application supporting a virtual scene. In some examples, the application 222 is an application supporting a three-dimensional virtual scene. The application 222 may be any one of a virtual reality application, a three-dimensional map program, an SLG game, a TPS game, an FPS game, a MOBA game, a casual party game, a tower defense game, or a community game. The application 222 may be a console application, for example, a console three-dimensional game program, or may be a network-connected application.

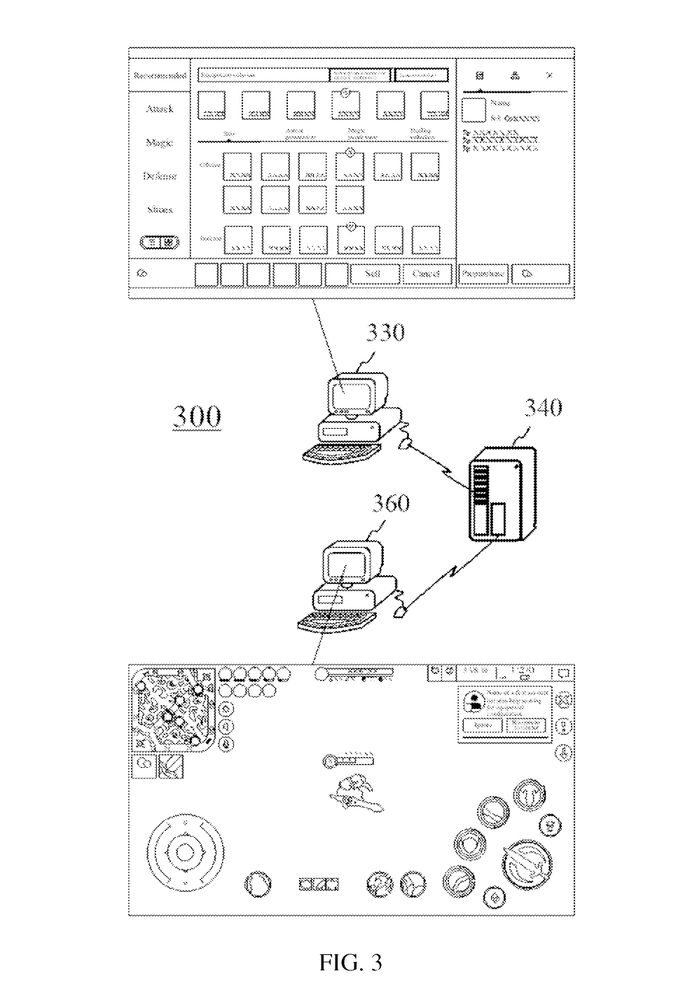

FIG. 3 is a structural block diagram of a computer system according to an example of this application. The computer system 300 includes a first device 330, a server 340, and a second device 360.

An application supporting a virtual scene is installed and run on the first device 330. The application may be any one of a virtual reality application, a three-dimensional map program, a TPS game, an FPS game, a MOBA game, an SLG game, a party game, or a tower defense game. The first device 330 is a device used by a first user. The first user uses the first device 330 to control a first virtual character in the virtual scene to perform an action. The action includes but is not limited to at least one of body posture adjustment, walking, running, jumping, and attacking. For example, the first virtual character is a first virtual human, for example, a simulated human character or a cartoon human character.

The first device 330 is connected to the server 340 via a wireless network or a wired network.

The server 340 includes at least one of a server, a plurality of servers, a cloud computing platform, and a virtualization center. The server 340 is configured to provide a backend service for an application supporting a three-dimensional virtual scene. In some examples, the server 340 undertakes main computing work, and the first device 330 and the second device 360 undertake secondary computing work. Alternatively, the server 340 undertakes secondary computing work, and the first device 330 and the second device 360 undertake main computing work. Alternatively, the server 340, the first device 330, and the second device 360 perform collaborative computing by using a distributed computing architecture.

The server 340 controls a second virtual character in the virtual scene to perform an action. The action includes but is not limited to at least one of body posture adjustment, walking, running, jumping, and attacking. For example, the second virtual character is a second virtual human, for example, a simulated human character or a cartoon human character.

An application supporting a virtual scene is installed and run on the second device 360. The application may be any one of a virtual reality application program, a three-dimensional map program, an FPS game, a MOBA game, an SLG game, a party game, or a tower defense game. The second device 360 is a device used by a second user. The second user uses the second device 360 to control a third virtual character in the virtual scene to perform an action. The action includes but is not limited to at least one of body posture adjustment, walking, running, jumping, and attacking. For example, the third virtual character is a third virtual human, for example, a simulated human character or a cartoon human character.

In some examples, the applications installed on the first device 330 and the second device 360 are the same, or the applications installed on the two devices are a same type of applications of different control system platforms. The first device 330 may generally be one of a plurality of devices, and the second device 360 may generally be one of a plurality of devices. In this example, the first device 330 and the second device 360 are used merely as an example for description. Device types of the first device 330 and the second device 360 are the same or different. In the following examples, an example in which the device is a desktop computer is used for description.

In some examples, a first account logs into the first device 330, a second account logs into the second device 360, and the first device 330 sends equipment help seeking information (e.g., an equipment assistance request) to the second device 360. The equipment help seeking information is configured for requesting the second account to recommend a virtual equipment to the first account, and the virtual equipment may be equipped by a first virtual character controlled by the first account. When the first device 330 sends the equipment help seeking information to the second device 360, a screen of the first device 330 correspondingly displays an equipment configuration interface; and when the second device 360 receives the equipment help seeking information from the first device 330, and a screen of the second device 360 also correspondingly displays an equipment configuration interface.

A person skilled in the art may learn that there may be more or fewer devices. For example, there may be only one device, or there may be dozens or hundreds of devices, or there may be more devices. The quantity of devices and the device type of the device are not limited in the examples of this application.

The server 340 may be implemented as a physical server, or may be implemented as a cloud server in a cloud. In some examples, when the server 340 is implemented as a cloud server, the program corresponding to the virtual scene may be a cloud game.

In some examples, a method provided in the examples of this application is applicable to a cloud game scenario, so that a cloud server completes computing of data logic in a game process, and a terminal is responsible for displaying a game interface.

In some examples, the server 340 may alternatively be implemented as a node in a blockchain system.

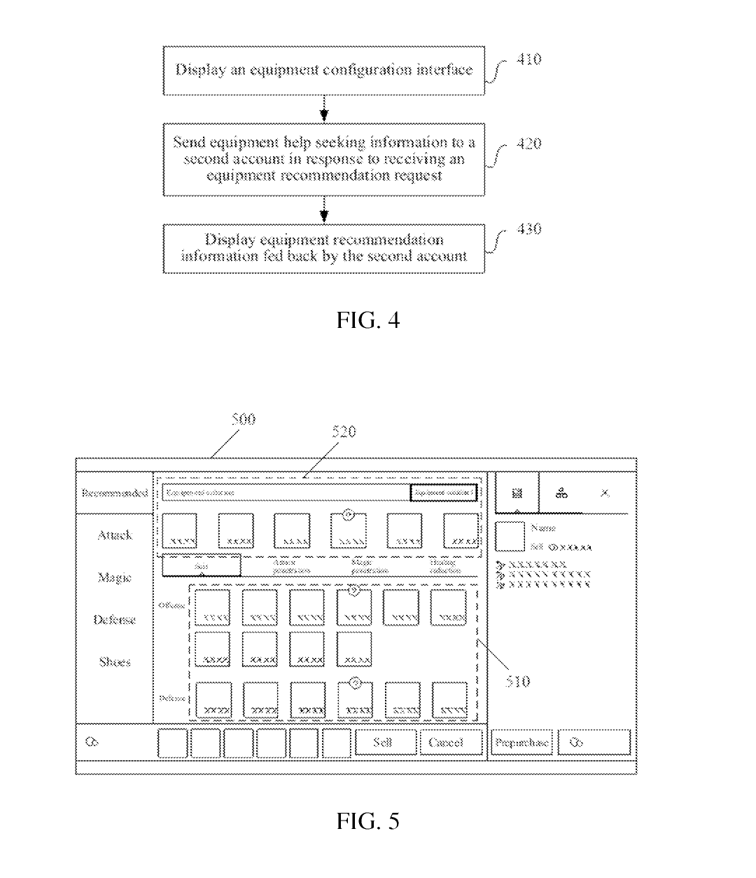

The information display method provided in this application is described with reference to the foregoing term introduction and application scenario. The method may be performed by a computer device (including a server and a terminal). In other words, the method may be performed by the server or the terminal, or may be jointly performed by the server and the terminal. In the examples of this application, an example in which the method is performed by the terminal is used for description. As shown in FIG. 4, FIG. 4 is a flowchart of a virtual equipment recommendation method according to an example of this application. The method includes the following operations:

Operation 410: Display an equipment configuration interface.

The equipment configuration interface is configured for configuring a virtual equipment for a first virtual character controlled by a first account, the virtual equipment is configured for providing an equipment effect for the first virtual character, and the equipment configuration interface includes a plurality of candidate equipments.

In some examples, types of the candidate equipments include, but are not limited to, the following types:

(1) Virtual equipment having an attack function: When the first virtual character is configured with the virtual equipment, combat power of the first virtual character can be improved in a virtual battle, and a win rate of the battle can be improved.

For example, a virtual battle is performed between a first virtual character and a second virtual character, when the first virtual character launches an attack to the second virtual character without being configured with any virtual equipment, damage caused to the second virtual character is five unit values, where the unit value may be any value. When the first virtual character launches an attack to the second virtual character when configured with the virtual equipment, damage caused to the second virtual character is added to 10 unit values.

(2) Virtual equipment with a defense function: When the first virtual character is configured with the virtual equipment, a defense capability of the first virtual character in a virtual battle can be improved, thereby improving a win rate of the battle.

For example, a virtual battle is performed between a first virtual character and a second virtual character, when the first virtual character receives an attack from the second virtual character without being configured with any virtual equipment, damage received by the first virtual character is 10 unit values. When the first virtual character receives an attack from the second virtual character when configured with the virtual equipment, damage received by the first virtual character is reduced to 5 unit values.

(3) Virtual equipment having a healing function: When the first virtual character is configured with the virtual equipment, if a health value of the first virtual character is less than a preset value, the health value of the first virtual character can be increased, thereby improving duration of the first virtual character in a battle.

For example, a virtual battle is performed between a first virtual character and a second virtual character, when a health value of the first virtual character is reduced to 5 unit values, if the first virtual character is configured with the virtual equipment, the health value of the first virtual character is increased by 20 unit values, that is, increased to 20+5=25 unit values. If the first virtual character is not configured with the virtual equipment, the health value of the first virtual character is not increased.

(4) Virtual equipment having a speed improvement function: When the first virtual character is configured with the virtual equipment, a moving speed of the first virtual character and an attack/evasion speed during a virtual battle can be improved, thereby improving a win rate in the battle.

For example, a virtual battle is performed between a first virtual character and a second virtual character. If the first virtual character is configured with the virtual equipment, a moving speed of the first virtual character is increased from 2 m/s to 5 m/s. When an attack speed of the second virtual character is 4 m/s, the first virtual character can evade an attack of the second virtual character.

(5) Virtual equipment with a battle rebound function: When the first virtual character is configured with the virtual equipment, the first virtual character can rebound some attacks when receiving the attacks.

For example, a virtual battle is performed between a first virtual character and a second virtual character. The second virtual character launches an attack to the first virtual character, and causes damage of 10 unit values to the first virtual character. If the first virtual character is configured with the virtual equipment, the first virtual character rebounds damage of 4 unit values to the second virtual character. In other words, when attacking the first virtual character, the second virtual character also causes partial damage to itself.

(6) Virtual equipment that provides a special attack manner: When the first virtual character is configured with the virtual equipment, the first virtual character can cause damage to another virtual character in the special attack manner.

Equipment appearances of virtual equipments are not completely the same. When a virtual character is configured with any one or more equipments in the foregoing virtual equipments, in addition to obtaining a fighting gain to some extent during a virtual battle, an appearance of the virtual character can also be modified.

In some examples, virtual equipments do not have substantial fighting gain functions, but may play a decorative role in terms of appearance, thereby increasing richness and fun of game pictures.

For example, a virtual equipment has a decorative function. When a first virtual character is configured with the virtual equipment, when the first virtual character launches an attack to a second virtual character, an attack effect is displayed, for example, a spark effect, a highlight effect, a background rendering effect, or an animation effect.

For example, FIG. 5 is a schematic diagram of an equipment configuration interface. The equipment configuration interface 500 includes a plurality of candidate equipments 510, and the candidate equipments 510 are classified and arranged according to functions of equipments. The equipment configuration interface 500 further includes default virtual equipments 520 recommended by a system to a player.

A plurality of types of virtual equipments are presented on the equipment configuration interface, and are arranged according to a sequence of functions. This can intuitively and briefly assist the player in quickly locating a target and selecting suitable virtual equipments for the first virtual character, thereby improving decision-making efficiency in terms of the virtual equipments.

In some examples, the equipment configuration interface is implemented as an interface provided by a virtual store in a virtual battle. In some examples, the plurality of candidate equipments provided in the equipment configuration interface are all virtual equipments provided in the virtual store. Alternatively, the plurality of candidate equipments provided in the equipment configuration interface are virtual equipments in the virtual store for which the first virtual character is capable of exchanging. For example, the first virtual character has a quantity of virtual resources, and the plurality of candidate equipments are virtual equipments in the virtual store whose corresponding quantities of virtual resources for exchange are less than or equal to the quantity of virtual resources possessed by the first virtual character. Alternatively, the plurality of candidate equipments provided in the equipment configuration interface are virtual equipments matching a character type of the first virtual character. For example, when the character type of the first virtual character is a wizard type, the plurality of candidate equipments are virtual equipments suitable for the wizard type. For another example, when the character type of the first virtual character is a tank type, the plurality of candidate equipments are virtual equipments suitable for the tank type.

Operation 420: Send equipment help seeking information to a second account in response to receiving an equipment recommendation request.

The equipment help seeking information is configured for requesting the second account to provide equipment recommendation information of the first virtual character to the first account.

In some examples, the equipment recommendation request is implemented as at least one of a request triggered by an operation triggered by a control, an operation triggered by a gesture, an operation triggered by a shortcut key, or an operation triggered by a user voice. This is not limited herein. In some examples, when the equipment recommendation request is a request implemented through an operation triggered by a gesture, the operation triggered by a gesture may be implemented as a press and hold operation, a click/tap operation, a drag operation, a heavy click/tap operation, a double-click/tap operation, or the like. This is not limited herein.

For example, an example in which the equipment help seeking operation is implemented as an operation triggered by a control is used. The equipment configuration interface includes an equipment help seeking control, and the equipment help seeking information is sent to the second account in response to receiving a control triggering request for the equipment help seeking control.

Detection of the control triggering request for the equipment help seeking control is implemented as follows: When a player touches a screen of a terminal, a sensor of the screen detects a capacitance change at a touch point, and converts the capacitance change into a coordinate signal. When a coordinate position indicated by the coordinate signal falls within a control coordinate range of the equipment help seeking control, whether the control triggering request for the equipment help seeking control is received is determined based on the coordinate signal. For example, using an example in which the control triggering request is implemented as a press and hold operation, whether the control triggering request for the equipment help seeking control is received is determined by determining whether a duration for which the coordinate signal is located within the control coordinate range reaches a preset duration threshold.

In some examples, a display form of the equipment help seeking control includes: presented in a form of a shape control, presented in a form of a text control, or presented in a form of a thumbnail control corresponding to any virtual equipment in the equipment configuration interface. For example, a thumbnail corresponding to a virtual equipment having the highest price is presented.

The equipment help seeking control is disposed in the equipment configuration interface, so that equipment help seeking can be quickly implemented with only a simple triggering operation, thereby improving convenience of a help seeking operation of a player, and improving help seeking efficiency and human-computer interaction efficiency.

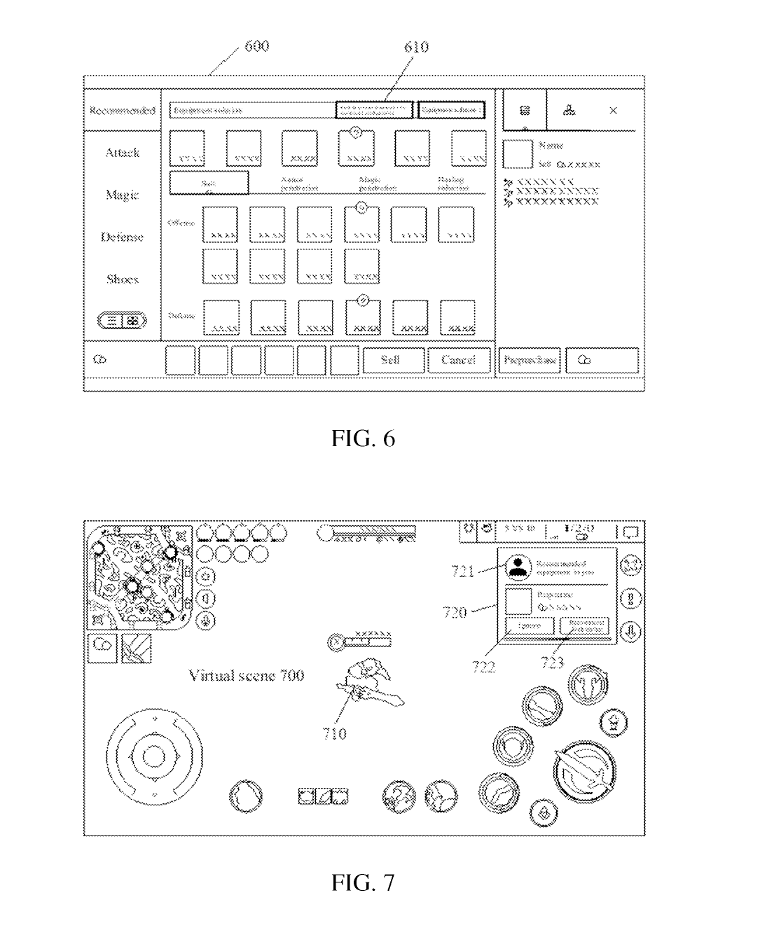

For example, FIG. 6 is a schematic diagram of triggering an equipment help seeking control.

An equipment configuration interface 600 includes an equipment help seeking control 610. The equipment help seeking control 610 is configured for sending equipment help seeking information to a second account. After the equipment help seeking control 610 is triggered, a first account client automatically sends the help seeking information to a second account client.

In some examples, a manner of triggering the equipment help seeking control includes at least one of single click, double click, triple click, tap, and long press, but is not limited thereto. This is not specifically limited in the examples of this application.

In some examples, a manner of sending the equipment help seeking information by using the equipment recommendation request includes, but is not limited to, the following several manners.

(1) Send the equipment help seeking information to a second account associated with a first account in response to receiving an equipment recommendation request.

In an example, an example in which the equipment recommendation request is implemented as an operation triggered by a control is used. In response to receiving a control triggering request for the equipment help seeking control, the equipment help seeking information is sent to the second account associated with the first account.

When the first account only has an association relationship with the second account, the equipment help seeking information may be directly sent to the second account. The association relationship between the first account and the second account includes, but is not limited to the following:

1. Friend relationship: There is a friend relationship between the first account and the second account.

2. Group chat relationship: A quantity of group chats that the first account and the second account both participate in reaches a preset threshold.

3. Marking relationship: A player of the first account marks the second account as an associated account, and the equipment help seeking information is sent to the marked second account by default.

4. Communication relationship: The first account and the second account have chatted once in a historical time period.

5. Teammate relationship: The first account and the second account belong to a same team in a current virtual battle, and the first account and the second account need to confront with battle accounts together.

The equipment help seeking information is directly sent to the second account having the association relationship with the first account, so that the equipment help seeking can be implemented without additional communication between the player of the first account and a player of the second account, thereby reducing operation time of the players, improving human-computer interaction efficiency, and improving efficiency of equipment help seeking. In the help seeking process, voice communication and typing communication do not need to be performed between the players, thereby satisfying a requirement that some players are not willing to turn on a microphone and communicate with each other, and improving experience of the players.

(2) Display an account list in response to receiving the equipment recommendation request, the account list including an associated account having an association relationship with the first account, and the associated account including the second account; and send the equipment help seeking information to the second account in response to receiving a selecting request for the second account.

In an example, an example in which the equipment recommendation request is implemented as an operation triggered by a control is used. In response to receiving a control triggering request for the equipment help seeking control, the account list is displayed; and in response to receiving a selecting request for the second account, the equipment help seeking information is sent to the second account.

When the first account has association relationships with a plurality of accounts, the player of the first account may also select a second account from the plurality of accounts to send the equipment help seeking information to.

For example, the first account has association relationships with a second account, a third account, and a fourth account. The second account has the highest account level, the third account participates in the largest number of virtual battles, and the fourth account communicates with the first account most frequently.

An association relationship between the first account and each of the second account, the third account, and the fourth account may be any one or more of the foregoing relationships. For example, both the friendship relationship and the marking relationship exist between the first account and the second account, the group chat relationship exists between the first account and the third account, and the communication relationship exists between the first account and the fourth account.

After the second account is selected from the account list and confirmed, the first account client sends the equipment help seeking information to the second account client.

When the first account player expects to seek help from other account players for equipment recommendation, all accounts having association relationships with the first account are displayed in a list form, so that more choices can be provided for the first account to seek help for equipment recommendation. This facilitates a player to properly select, based on factors such as battle performance of different players in the game, account levels, and association closeness with the account, a target player to recommend equipments to the player, thereby improving an equipment recommendation effect to some extent.

(3) Display a candidate equipment type in response to receiving the equipment recommendation request, the candidate equipment type respectively corresponding to an equipment configuration account, and the equipment configuration account including the second account corresponding to a first equipment type; and send the equipment help seeking information to the second account corresponding to the first equipment type in response to receiving a selecting request for the first equipment type.

In an example, an example in which the equipment recommendation request is implemented as an operation triggered by a control is used. In response to receiving a control triggering request for the equipment help seeking control, candidate equipment types are displayed; and in response to receiving a selecting request for the first equipment type, the equipment help seeking information is sent to the second account corresponding to the first equipment type.

The candidate equipment type includes at least one of an attack function type, a defense function type, a healing function type, and a speed improvement function type.

In some examples, descriptions are provided by using an example in which the candidate equipment types include the foregoing four equipment types. When the first account performs a virtual battle, in a unit of a team, the first account has a plurality of teammate accounts, which are respectively: a second account, a third account, a fourth account, and a fifth account.

An equipment configuration account respectively corresponding to each candidate equipment type may be any one of the foregoing four teammate accounts.

In some examples, an association relationship between the candidate equipment type and the equipment configuration account may be determined based on an association relationship between the candidate equipment type and a character type of a virtual character controlled by the equipment configuration account. For example, when the candidate equipment type is the defense function type, the corresponding equipment configuration account is an account controlling a tank virtual character in a team. For another example, when the candidate equipment type is the healing function type, the corresponding equipment configuration account is an account controlling a support virtual character in a team.

(4) Receive a selecting request for at least two candidate equipments in the plurality of candidate equipments; and send the equipment help seeking information to the second account in response to receiving the equipment recommendation request, the equipment help seeking information including equipment information of the at least two candidate equipments, and the equipment help seeking information being configured for indicating the second account to perform equipment recommendation between the at least two candidate equipments.

In other words, after selecting the at least two candidate equipments in the equipment configuration interface, the first account player sends the equipment help seeking information to the second account, and the second account player decides, for the first account player based on the equipment information of the at least two candidate equipments included in the equipment help seeking information, a virtual equipment to be equipped by the first virtual character.

In some examples, the equipment help seeking information sent by the first account includes equipment information of the first equipment, the second equipment, and the third equipment. The first equipment can improve an attack capability of the first virtual character in a virtual battle, the second equipment can improve a defense capability of the first virtual character in the virtual battle, and the third equipment is only configured for decorating an appearance of the first virtual character.

For example, there is a teammate relationship between the first account and the second account. In other words, the first account and the second account need to confront battle accounts together in a current virtual battle. Because a second virtual character controlled by the second account is already equipped with a second equipment, a player of the second account selects a first equipment among the first equipment, the second equipment, and a third equipment to recommend to a player of the first account.

Based on the manner in which the first account player voluntarily selects the at least two candidate equipments, and seeks help from the second account player for deciding a target equipment to be configured for the first virtual character in the at least two candidate equipments, not only can a sense of participation of the first account player be ensured when the first account player selects equipments for the virtual character of the first account player, but suggestions can also be effectively obtained from other players, thereby improving an equipment recommendation effect, and enabling the player to rapidly learn how to select suitable virtual equipments in the help seeking process. In addition, in comparison with a manner in which the second account player directly selects a virtual equipment for the first account player on the equipment configuration interface, the manner in which the first account player selects the candidate equipments and then the second account player determines the virtual equipment can first screen out some virtual equipments that are not in consideration of the first account player, so that the second account player can directly skip a screening operation, and make a decision within a smaller equipment range, thereby improving the efficiency of equipment help seeking, reducing a duration consumed by the second account player to recommend equipments to the first account player, and improving the human-computer interaction efficiency.

In some examples, in addition to the manner of triggering the equipment help seeking control to initiate equipment help seeking to the second account, another manner may be used, for example, initiating equipment help seeking by using a slide operation, or directly opening a teammate voice panel to perform help seeking. This is not limited in this application.

Operation 430: Display the equipment recommendation information fed back by the second account.

For example, in response to receiving the equipment recommendation information fed back by the second account, the equipment recommendation information is displayed. The equipment recommendation information includes a candidate equipment recommended by the second account to the first account. In some examples, there may be one or more candidate equipments recommended by the second account to the first account.

After the second account receives and confirms the equipment help seeking information, the equipment configuration interface of the first account is displayed on a display screen of a terminal to which the second account is logged in. A player of the second account can directly view a plurality of candidate equipments on the equipment configuration interface, and select at least one virtual equipment from the plurality of candidate equipments as the virtual equipment recommended to the first account.

For example, referring to FIG. 7, FIG. 7 is a schematic diagram of receiving and displaying equipment recommendation information by a first account.

A terminal displays a first virtual character 710 located in a virtual scene 700, and displays equipment recommendation information 720 when a second account completes recommendation to a first account.

The equipment recommendation information 720 includes the following content:

(1) an avatar identifier 721 of the second account and corresponding text prompt information, where the avatar identifier 721 of the second account is configured for indicating an identity of the second account, and indicates that the equipment recommendation information is fed back by the second account to the first account, and the text prompt information is "recommended equipment to you", indicating that the second account has recommended the virtual equipment to the first account;

(2) information about a virtual equipment recommended by the second account to the first account, such as a name of the virtual equipment, an outline thumbnail of the virtual equipment, and a function of the virtual equipment, configured to assist the first account in determining whether to receive recommendation of the second account;

(3) a recommendation ignore control 722, where when the control is triggered, the recommendation information of the second account is ignored, and the first account selects the virtual equipment autonomously; and

(4) a recommendation control 723, where when the control is triggered, the first account can reversely recommend a virtual equipment to the second account.

The corresponding text prompt information and the equipment information of the virtual equipment recommended by the second account are displayed in the equipment recommendation information, to help the first account learn that the current equipment help seeking is fed back by the second account player, and assist the first account player in deciding whether to directly exchange for the virtual equipment recommended in the equipment recommendation information, thereby improving equipment recommendation efficiency.

In some examples, after the first account successfully sends the equipment help seeking information to the second account, if the second account receives the information and agrees to help, particular selection time is needed. In a process in which the first account waits for the second account to feed back, help seeking progress information is displayed on a terminal screen, and the help seeking progress information is configured for indicating a help seeking progress at which the first account is located in a process of equipment help seeking.

In some examples, the help seeking progress information may be implemented as a difference between a quantity of virtual equipments that the second account currently selects to recommend to the first account and a quantity of virtual equipments that the first account needs to be recommended. In other words, the help seeking progress information indicates a recommendation progress of equipment recommendation by the second account. The quantity of virtual equipments that the first account needs to be recommended may be preset by a system, may be customized by the first account, or may be determined based on a quantity of vacancies in equipment bars corresponding to the first virtual character. For example, the second account needs to recommend four virtual equipments to the first account, and when the second account selects three virtual equipments for the first account, the help seeking progress information is "75% progress".

In some examples, the help seeking progress information may be implemented as a countdown duration of the first account in the equipment help seeking process. In other words, the help seeking progress information is a progress bar, and the progress bar correspondingly has a fixed countdown duration. In some examples, the fixed countdown duration may be a countdown duration preset by a system, or may be a countdown duration customized by the first account. For example, the fixed countdown duration is 20 seconds, and a length of the progress bar also changes accordingly in a change process of the duration.

For example, referring to FIG. 8, FIG. 8 is a schematic diagram of displaying help seeking progress information.

A terminal displays a first virtual character 810 located in a virtual scene 800, and after a first account finishes sending equipment help seeking information to a second account, the terminal displays help seeking progress information 820. In a recommendation process of the second account to the first account, the help seeking progress information 820 correspondingly changes. As shown in FIG. 8, the help seeking progress information 820 is presented as a progress bar and text prompt information "60% progress".

The help seeking progress information is displayed, to help the player understand a progress of the current equipment recommendation procedure, so that avoid problems that aimless waiting of the player consumes relatively long time and poor player experience due to unclear progress, thereby ensuring efficiency of interaction between the player and the device. In other words, in the process in which the first account seeks help from the second account, the help seeking progress information is presented, so that a first account player can quickly learn a current help seeking progress, and synchronously perform another operation in a waiting process, thereby reducing impact of the help seeking waiting process on participation of the first account in a game, avoiding a delaying impact on an entire game progress, improving human-computer interaction efficiency in the game process, ensuring successful progress of a game battle, and avoiding a waste of battery power of a terminal.

After the second account feeds back equipment recommendation information to the first account, the first account player can directly choose to accept recommendation of the second account, and directly perform exchange on the equipment configuration interface by using an equal amount of virtual resources. After a virtual equipment obtained through exchange is configured for a first virtual character, the first virtual character performs a virtual battle.

In some examples, the first account player may alternatively ignore the equipment recommendation information fed back by the second account. For example, a fighting gain effect of a virtual equipment recommended by the second account to the first virtual character does not meet an expectation, or the first account does not meet a condition of being capable of exchanging for the virtual equipment recommended by the second account (for example, an account level of the first account is level 10, and the virtual equipment recommended by the second account can be exchanged for only when the account level reaches level 20).

In some examples, in response to receiving an ignoring instruction for the equipment recommendation information, displaying the equipment recommendation information is canceled, and the recommendation procedure ends.

In some examples, after the first account sends the equipment help seeking information to the second account, the second account may alternatively choose to ignore the equipment help seeking information of the first account. A duration for which the first account waits for the second account to feed back has a duration threshold. If the waiting duration reaches the duration threshold, and the second account still does not feed back the equipment recommendation information to the first account, the recommendation procedure ends.

Setting the duration threshold for the feedback can prevent the first account from waiting for relatively long time when the first account does not receive the feedback from the second account, so that the first account can change a help seeking target in time or make a decision about a virtual equipment that needs to be exchanged for autonomously, thereby ensuring experience of the player in the help seeking process and efficiency of the equipment recommendation process.

In some examples, the first account may simultaneously send the equipment help seeking information to a plurality of associated accounts. For example, the first account has three teammate accounts in a virtual battle, which are respectively a second account, a third account, and a fourth account, and equipment help seeking information may be simultaneously sent to the three accounts. Each teammate account not only may choose to recommend virtual equipments to the first account, but also may choose to ignore the equipment help seeking information.

In some examples, when a plurality of accounts respond to the equipment help seeking information, and the second account is an account that first feeds back equipment recommendation information to the first account, regardless of whether the third account and the fourth account feed back equipment recommendation information to the first account, the equipment recommendation procedure ends.

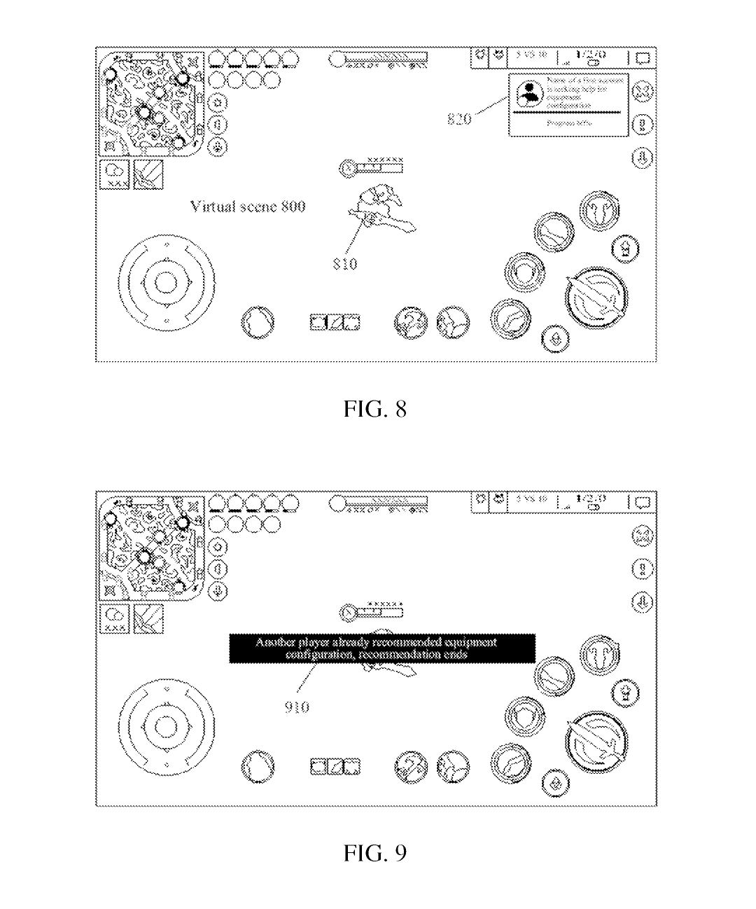

For example, as shown in FIG. 9, FIG. 9 is a schematic diagram of ending an equipment recommendation procedure.

Using a perspective of a third account as an example, after the third account receives equipment help seeking information sent by a first account, the third account may recommend a virtual equipment to the first account. In a decision-making process of the third account, a second account completes equipment recommendation to the first account first, and equipment recommendation ending prompt information 910 is displayed, indicating that the equipment recommendation ends.

In some examples, when a plurality of accounts respond to the equipment help seeking information, the accounts are displayed, according to a sequence of feeding back the equipment recommendation information, on a display screen of a terminal to which the first account is logged in. A first account player can view virtual equipments respectively recommended by different equipment recommendation information, and select one of the virtual equipments as a virtual equipment to be equipped on the first virtual character. Alternatively, the first account player may choose to ignore all the equipment recommendation information.

In some examples, to improve efficiency of interaction between the first account and the second account, and reduce decision-making time, the first account may directly use a virtual equipment configured for a second virtual character controlled by the second account as the virtual equipment configured for the first virtual character, without initiating the equipment help seeking information.

In some examples, in response to receiving an equipment reference request for the second account, information about the virtual equipment configured for the second virtual character is displayed, the second virtual character being a virtual character controlled by the second account.

For example, the second virtual character is configured with a first equipment, and the first equipment can be exchanged for on the equipment configuration interface. When the equipment reference request is received, an effect of the first virtual character configured with the first equipment is previewed; and when an equipment exchange request is received, the same first equipment is exchanged for to be configured for the first virtual character.

In some examples, the first account player may separately configure different virtual equipments for different character parts of the first virtual character according to an appearance of the first virtual character, for example, a virtual equipment of costumes, a virtual equipment of shoes, and a virtual equipment of pants of the first virtual character. The first account player may select virtual equipments for some parts of the first virtual character, and the second account player recommends virtual equipments for other parts of the first virtual character.

In some examples, the equipment help seeking information is sent to the second account in response to receiving a selecting request for a first equipment and the equipment recommendation request, the equipment help seeking information including the first equipment, the first equipment being an equipment currently configured for the first virtual character, and the equipment help seeking information being configured for requesting the second account to recommend a virtual equipment matching the first equipment.

For example, the first equipment is a top equipment and a pants equipment of the first virtual character, and the equipment help seeking information is configured for requesting the second account to recommend a virtual shoes equipment matching the first equipment.

In other words, the first account indicates the currently equipped first equipment to the second account, so that the second account player can recommend, based on the first equipment, a virtual equipment matching the first equipment in a targeted manner, thereby improving selection efficiency of the second account when selecting the recommended virtual equipment, reducing impact of an equipment recommendation requirement of the first account on a game process of another account, and further improving game process efficiency of an overall game battle.

In some examples, to reduce the number of times of seeking help from other players, in addition to initiating, by the first account player, help seeking to the second account player before each virtual battle, the second account player may also recommend, to the first account player at a time, virtual equipments that can be used during a plurality of future virtual battles.

In some examples, an equipment chain in the equipment recommendation information is displayed in response to receiving the equipment recommendation information fed back by the second account, the equipment chain including a plurality of candidate recommended equipments, and the equipment chain being configured for indicating to exchange for the plurality of candidate recommended equipments in a chain sequence.

Types and a quantity of the candidate recommended equipments in the equipment chain may be arbitrary. In some examples, the first account does not have a condition of exchanging for all the virtual equipments in the equipment chain at a current moment, only a part of virtual equipments that can be exchanged for at the current moment may be purchased according to the chain sequence of the equipment chain, and the first account may perform exchange when the first account has a condition of exchanging for a part of virtual equipments that have not have been exchanged for at a future moment. The equipment chain information may be stored in game data for the first account player to view at any time.

In some examples, when the first account accepts the equipment chain recommended by the second account, in response to a case that the first virtual character has exchanged for an n^{th} piece of candidate recommended equipment on the equipment chain and virtual resources possessed by the first virtual character are sufficient to exchange for an (n+1)^{th} candidate recommended equipment on the equipment chain, an exchange result of the first virtual character automatically exchanging for the (n+1)^{th} candidate recommended equipment is displayed, n being a positive integer.

For example, the equipment chain includes 20 candidate recommended equipments, and the candidate recommended equipment are respectively arranged in ascending order of account levels. An exchangeable level of the 1^{st} to the 5^{th} candidate recommended equipments is 10, an exchangeable level of the 6^{th} to the 15^{th} candidate recommended equipments is 15, and an exchangeable level of the 16^{th} to the 20^{th} candidate recommended equipments is 20. A quantity of virtual resources required by each candidate recommended equipment is 200.

For example, n is 14, and an account level of the first account is 17. At a first moment, a total quantity of virtual resources possessed by the first account is 50, and the first account has already exchanged for the 1^{st} to the 14^{th} candidate recommended equipments in the equipment chain. At a second moment, a total quantity of virtual resources possessed by the second account is 300. In this case, the 15^{th} candidate recommended equipment is automatically exchanged for, and the total quantity of virtual resources possessed by the second account changes to 300 – 200 = 100. The second moment is a moment in a future time period of the first moment.

The manner of recommending the equipment chain to the first account can reduce the number of times of requesting, by the first account, another account to recommend virtual equipments, and can also ensure that the first account can implement equipment exchange based on the candidate recommended equipments in the equipment chain in a subsequent game process, thereby accelerating an overall game process, reducing battle duration of a game battle, and reducing power consumption of a device during the game battle.

In some examples, a background data flow of the virtual equipment recommendation method provided in this application is implemented as follows: After receiving an equipment recommendation request, a first account client generates equipment help seeking information, the equipment help seeking information including an account identifier of a second account from which a first account seeks help. The first account client sends the equipment help seeking information to a server. The server parses the equipment help seeking information and caches battle data, determines, based on the account identifier of the second account obtained through parsing, a second account client to which the second account logs in, and forwards the equipment help seeking information to the second account client. After receiving the equipment help seeking information, the second account client displays the equipment help seeking information. The second account client generates equipment recommendation information based on a received equipment recommendation instruction. The second account client sends the equipment recommendation information to the server. The server forwards the equipment recommendation information and caches the battle data. In other words, the server sends the equipment recommendation information to the first account client. The first account client displays the received equipment recommendation information to indicate a candidate equipment recommended by the second account to the first account.

According to the method provided in this application, when a virtual equipment is configured for a first virtual character, equipment help seeking information is sent to a second account by using an equipment recommendation request, to instruct, by using the second account, how to equip the virtual equipment. Equipment recommendation information fed back by the second account based on the equipment help seeking information is displayed, so that an equipment recommended by the second account to the first account can be intuitively presented, and a player of the first account can be assisted in selecting the to-be-equipped virtual equipment. In this way, decision-making time of the player is reduced, efficiency of configuring the virtual equipment by the player and human-computer interaction efficiency are improved. In addition, a battle process of a game battle can be accelerated, thereby reducing power consumption when a device is supporting the game battle.

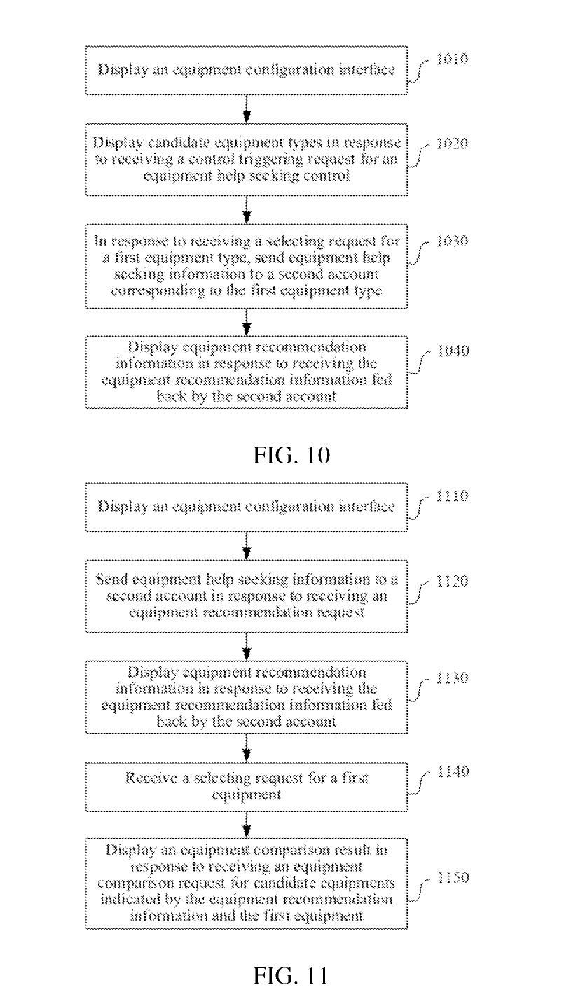

In some examples, a plurality of different virtual equipment may be simultaneously configured for a virtual character, to respectively bring different gain effects to the virtual character during virtual battle. To improve equipment recommendation efficiency, virtual equipments with different gain effects may be recommended to the first account by a plurality of associated accounts. As shown in FIG. 10, FIG. 10 is a flowchart of a virtual equipment recommendation method according to another example of this application. The method includes the following operations:

Operation 1010: Display an equipment configuration interface.

The equipment configuration interface is configured for configuring a virtual equipment for a first virtual character controlled by a first account, the virtual equipment is configured for providing an equipment effect for the first virtual character, and the equipment configuration interface includes a plurality of candidate equipments.

In some examples, the first virtual character may be simultaneously equipped with the following several types of virtual equipments:

(1) Virtual equipment having an attack function (first-type equipment for short below): When the first virtual character is configured with the virtual equipment, combat power of the first virtual character can be improved in a virtual battle.

(2) Virtual equipment with a defense function (second-type equipment for short below): When the first virtual character is configured with the virtual equipment, a defense capability of the first virtual character in a virtual battle can be improved.

(3) Virtual equipment having a healing function (third-type equipment for short below): When the first virtual character is configured with the virtual equipment, if a health value of the first virtual character is less than a preset value, the health value of the first virtual character can be increased, thereby improving duration of the first virtual character in a battle.

(4) Virtual equipment having a speed improvement function (fourth-type equipment for short below): When the first virtual character is configured with the virtual equipment, a moving speed of the first virtual character and an attack/evasion speed during a virtual battle can be improved. For example, in the equipment configuration interface, each type of virtual equipment corresponds to a plurality of candidate equipments, and the first account player may select one equipment from each type of virtual equipment to be equipped by the first virtual character.

For example, the first-type equipment includes a first-type equipment A and a first-type equipment B. The first account may select either one of the first-type equipment A and the first-type equipment B to be configured for the first virtual character. Alternatively, the first account may not select any equipment of the first-type equipment.

Operation 1020: Display candidate equipment types in response to receiving a control triggering request for an equipment help seeking control.

The equipment configuration interface includes an equipment help seeking control. The equipment help seeking control is configured for sending equipment help seeking information to an associated account (a teammate account) of the first account, to request the associated account to recommend a virtual equipment to the first account.

The candidate equipment types include, but are not limited to, the four types of virtual equipments (the first-type equipment, the second-type equipment, the third-type equipment, and the fourth-type equipment) exemplified in operation 1010.

The candidate equipment types respectively correspond to equipment configuration accounts.

In some examples, descriptions are provided by using an example in which the candidate equipment types include the foregoing four equipment types. When the first account performs a virtual battle, in a unit of a team, the first account has a plurality of teammate accounts, which are respectively: a second account, a third account, a fourth account, and a fifth account.

An equipment configuration account respectively corresponding to each candidate equipment type may be any one of the foregoing four teammate accounts.

In some examples, an association relationship between the candidate equipment type and the equipment configuration account may be determined based on an association relationship between the candidate equipment type and a character type of a virtual character controlled by the equipment configuration account. For example, when the candidate equipment type is the defense function type, the corresponding equipment configuration account is an account controlling a tank virtual character in a team. For another example, when the candidate equipment type is the healing function type, the corresponding equipment configuration account is an account controlling a support virtual character in a team.

The association relationships between the plurality of associated accounts that recommend equipments to the first account and the first account may be any relationship. The associated account is a teammate account that participates in a virtual battle together with the first account, and is merely used for exemplary purposes. A quantity of teammate accounts of the first account may be any quantity, which is not limited in the examples.

By selecting corresponding equipment configuration accounts for different candidate equipment types, a player can simultaneously seek help from a plurality of associated account players, so that each player from whom help is sought needs to be responsible for recommendation in only one equipment type, and an equipment recommendation help-seeking task is divided into a plurality of subtasks that are synchronously performed, thereby improving the equipment recommendation efficiency. In comparison with the manner of seeking help from one player for all types of virtual equipments, and the manner of seeking help from different players according to a sequence, the equipment recommendation manner provided in the examples can reduce duration of equipment help seeking and equipment recommendation, and reduce a recommendation burden of each player, thereby improving game experience of the player and efficiency of equipment selection, and improving human-computer interaction efficiency.

Operation 1030: In response to receiving a selecting request for a first equipment type, send equipment help seeking information to a second account corresponding to the first equipment type.

Using the second account as an example, the equipment help seeking information sent to the second account is configured for requesting the second account to provide equipment recommendation information of the first virtual character to the first account.

In some examples, the candidate equipment types include a first equipment type, a second equipment type, a third equipment type, and a fourth equipment type (that is, the first-type equipment to the fourth-type equipment in operation 1010, and details are not described herein again). Each equipment type corresponds to a plurality of candidate equipments.

The first account may separately select a corresponding equipment configuration account for each candidate equipment type. Using the second account as an example, an equipment configuration account corresponding to the first equipment type is the second account, a selecting request for the first equipment type is received, and corresponding equipment help seeking information is sent to the second account.

For example, the equipment configuration account corresponding to the first equipment type is the second account, an equipment configuration account corresponding to the second equipment type is the third account, an equipment configuration account corresponding to the third equipment type is the fourth account, and an equipment configuration account corresponding to the fourth equipment type is the fifth account.

After selecting requests for different equipment types are received, equipment help seeking information A is sent to the second account (where the equipment help seeking information A is configured for requesting the second account to select at least one virtual equipment from a plurality of candidate equipments of the first equipment type), equipment help seeking information B is sent to the third account (where the equipment help seeking information B is configured for requesting the third account to select at least one virtual equipment from a plurality of candidate equipments of the second equipment type), equipment help seeking information C is sent to the fourth account (where the equipment help seeking information C is configured for requesting the fourth account to select at least one virtual equipment from a plurality of candidate equipments of the third equipment type), and equipment help seeking information D is sent to the fifth account (where the equipment help seeking information D is configured for requesting the fifth account to select at least one virtual equipment from a plurality of candidate equipments of the fourth equipment type),

Operation 1040: Display the equipment recommendation information in response to receiving the equipment recommendation information fed back by the second account.

Using the second account as an example, the equipment recommendation information fed back by the second account includes a candidate equipment recommended by the second account to the first account.

In some examples, when a second account, a third account, a fourth account, and a fifth account all feed back equipment recommendation information to the first account, equipment recommendation information from different accounts includes different candidate equipments.

For example, a first equipment type corresponds to the following candidate equipments: a first equipment A, a first equipment B, and a first equipment C; a second equipment type corresponds to the following candidate equipments: a second equipment A, a second equipment B, and a second equipment C; a third equipment type corresponds to the following candidate equipments: a third equipment A and a third equipment B; and a fourth equipment type corresponds to the following candidate equipments: a fourth equipment A, a fourth equipment B, a fourth equipment C, and a fourth equipment D.

The second account feeds back equipment recommendation information A to the first account, and a candidate equipment recommended by the equipment recommendation information A is the first equipment A; the third account feeds back equipment recommendation information B to the first account, and a candidate equipment recommended by the equipment recommendation information B is the second equipment C; the fourth account feeds back equipment recommendation information C to the first account, and a candidate equipment recommended by the equipment recommendation information C is the third equipment B; and the fifth account feeds back equipment recommendation information D to the first account, and a candidate equipment recommended by the equipment recommendation information D is the fourth equipment D.

In some examples, different types of candidate equipments may alternatively correspond to a plurality of equipment configuration accounts, and each associated account may alternatively recommend a plurality of candidate equipment types simultaneously. For example, equipment configuration accounts corresponding to the first equipment type are the third account and the fifth account; and the second account may perform recommendation in the first equipment type and the third equipment type simultaneously. This is not limited in the examples.

According to the method provided in this application, when virtual equipments are configured for a first virtual character, an equipment recommendation request is received, to send equipment help seeking information respectively to a plurality of associated accounts, and the equipment help seeking information can request the plurality of associated accounts to respectively provide equipment recommendation information of the first virtual character for the first account. The equipment recommendation information fed back by the plurality of associated accounts is received and displayed, so that equipments respectively recommended by the plurality of associated accounts to the first account can be intuitively presented, thereby assisting the first account player in selecting and equipping virtual equipments having different functions, reducing decision-making time of the player, and improving efficiency of configuring the virtual equipments by the player and human-computer interaction efficiency.

In some examples, a novice player may select a virtual equipment autonomously or may initiate help seeking to an associated account to request the associated account to recommend an equipment to the novice player. To better help the player understand a reason for recommending the equipment, and master as soon as possible a skill of selecting the virtual equipment autonomously, a comparison and scoring mechanism may be introduced, to perform comparison between and scoring of the virtual equipment selected by the player and the virtual equipment recommended by the associated account, to determine a virtual equipment that is more suitable for a virtual character. FIG. 11 is a flowchart of a virtual equipment recommendation method based on a comparison result according to an example of this application. As shown in FIG. 11, the method includes the following operations:

Operation 1110: Display an equipment configuration interface.

The equipment configuration interface is configured for configuring a virtual equipment for a first virtual character controlled by a first account, the virtual equipment is configured for providing an equipment effect for the first virtual character, and the equipment configuration interface includes a plurality of candidate equipments.

In some examples, the equipment configuration interface includes an equipment help seeking control, and the equipment help seeking control is configured for initiating equipment help seeking to a second account.

Operation 1120: Send equipment help seeking information to the second account in response to receiving an equipment recommendation request.

In some examples, when a control triggering request for the equipment help seeking control is received, the equipment help seeking information is sent to the second account. The equipment help seeking information is configured for requesting the second account to provide equipment recommendation information of the first virtual character to the first account.

Operation 1130: Display the equipment recommendation information in response to receiving the equipment recommendation information fed back by the second account.

The equipment recommendation information includes a candidate equipment recommended by the second account to the first account.

In some examples, after receiving the equipment recommendation information fed back from the second account, the first account player may choose to directly exchange for the virtual equipment recommended by the second account. A plurality of candidate equipments and a quantity of virtual resources that need to be consumed to exchange for each virtual equipment are displayed on the equipment configuration interface. When a quantity of virtual resources possessed by the first account can exchange for the virtual equipment, the virtual equipment may be directly exchanged for. If the quantity of the virtual resources possessed by the first account does not reach a requirement for exchanging for the virtual equipment, exchange fails.

In some examples, after the equipment recommendation information is displayed, in response to receiving an exchange statistics request for the equipment recommendation information, a total exchanging quantity of virtual resources needed to exchange for a candidate equipment indicated by the equipment recommendation information is displayed, where the virtual resources are configured for exchanging for the virtual equipment in the equipment configuration interface.

For example, the second account recommends suit equipments to the first account. The suit equipments include three virtual equipments, which are respectively a virtual equipment A, a virtual equipment B, and a virtual equipment C. A quantity of virtual resources needed to exchange for the virtual equipment A is 100, a quantity of virtual resources needed to exchange for the virtual equipment B is 400, and a quantity of virtual resources needed to exchange for the virtual equipment C is 200.

When the exchange statistics request for the equipment recommendation information is received, the displayed total exchanging quantity of virtual resources is 700 (100 + 400 + 200 = 700).

When the equipment exchange request for the candidate equipment indicated by the equipment recommendation information is received, and when the total quantity of virtual resources possessed by the first account is greater than or equal to the total exchanging quantity, exchange success prompt information is displayed.

For example, the total quantity of virtual resources possessed by the first account is 1000, which is greater than the total exchanging quantity of virtual resources, to be specific, 700, required to exchange for the candidate equipment indicated by the equipment recommendation information. In this case, the exchange succeeds, and displayed exchange success prompt information is "Exchange success, viewing equipment effect".

The first virtual character configured with the candidate equipment indicated by the equipment recommendation information is displayed.

If the total quantity of virtual resources possessed by the first account is less than the total exchanging quantity of virtual resources, the exchange fails, and exchange failure prompt information is correspondingly displayed.

For example, the total quantity of virtual resources possessed by the first account is 500, which is less than the total exchanging quantity of virtual resources, to be specific, 700. In this case, displayed exchange failure prompt information is "Exchange fails, insufficient quantity of virtual resources".

By providing an exchange statistics function, a total quantity of virtual resources needed for a virtual equipment that is expected to be exchanged for can be directly calculated for the player, and the player does not need to memorize and perform calculation autonomously, thereby reducing a memorizing load of the player. When a quantity of virtual equipments indicated in the equipment recommendation information and the total exchanging quantity of virtual resources are relatively large, a calculation problem can be conveniently resolved for the player, thereby improving efficiency of the player in deciding to exchange for virtual equipments and human-computer interaction efficiency.

Operation 1140: Receive a selecting request for a first equipment.

The plurality of candidate equipments presented on the equipment display interface includes a first equipment and a second equipment. The first equipment is a virtual equipment selected by the first account player.

Operation 1150: Display an equipment comparison result in response to receiving an equipment comparison request for the candidate equipment indicated by the equipment recommendation information and the first equipment.

The equipment comparison result is configured for indicating a difference between the candidate equipment indicated by the equipment recommendation information and the first equipment.

For example, a candidate equipment indicated by equipment recommendation information of the second account is the second equipment, and when an equipment comparison request between the first equipment and the second equipment is received, an equipment comparison result is displayed.

For example, the equipment comparison result may be obtained through comparison from the following several aspects:

(1) A price of the virtual equipment/a quantity of virtual resources needed to exchange for the virtual equipment: For example, a quantity of virtual resources needed to exchange for the first equipment is 1000, and a quantity of virtual resources needed to exchange for the second equipment is 800.

(2) A gain effect of the virtual equipment in a virtual battle: For example, the first equipment can improve an attack capability of the first virtual character to 150%, and improve a defense capability of the first virtual character to 120%; and the second equipment can improve the attack capability of the first virtual character to 120%, and improve the defense capability of the first virtual character to 140%.

(3) Whether an additional gain effect exists between the virtual equipment and the first virtual character: For example, an equipment attribute of the first equipment can bring an additional gain effect to the first virtual character, and increase a health value of the first virtual character; and an equipment attribute of the second equipment cannot bring an additional gain effect to the first virtual character.

(4) Whether the player needs to perform other operations when the virtual equipment provides the gain effect for the virtual character: For example, the first account player does not need to perform other operations when the first equipment provides the gain effect for the virtual character, and the first account player does not need to perform other operations when the second equipment provides the gain effect for the virtual character.

In some examples, in addition to comparison of the foregoing dimensions, the equipment comparison result further includes scores of the two virtual equipments.

For example, based on the foregoing several comparison dimensions, a score of the first equipment is 90/100, a score of the second equipment is 85/100, the score of the first equipment is higher than the score of the second equipment, and the game system more recommends the first account to select the first equipment as the equipment configured for the first virtual character.

The equipment comparison function is provided, so that a player knows an equipment recommendation result when seeking help from another player, and a chance of comparison and learning is also provided for the player. In other words, the player selects a set of equipments autonomously, and then the another player recommends a set of equipments. By comparing differences between different equipments, the player is helped to learn and master, as soon as possible, a skill of how to select virtual equipments. The equipment comparison result compares the differences between the virtual equipments from a plurality of dimensions, and this can provide a focus for the player to select virtual equipments, thereby improving human-computer interaction efficiency. A scoring result is added to the equipment comparison result. In this way, even if a novice player does not know what functions these equipment terms or comparison dimensions can play in a virtual battle, the novice player can directly select a virtual equipment with a higher score as the equipment configured for the first virtual character, so that it is easier to understand the comparison result.

According to the method provided in this application, when virtual equipments are configured for a first virtual character, an equipment recommendation request is received, to send equipment help seeking information to a second account, and the equipment help seeking information can request the second account to provide equipment recommendation information of the first virtual character for the first account. The equipment recommendation information fed back by the second account is received and displayed, so that equipments recommended by the second account to the first account can be intuitively presented, thereby assisting the first account player in selecting virtual equipments to be equipped, reducing decision-making time of the player, and improving efficiency of configuring the virtual equipments by the player and human-computer interaction efficiency.

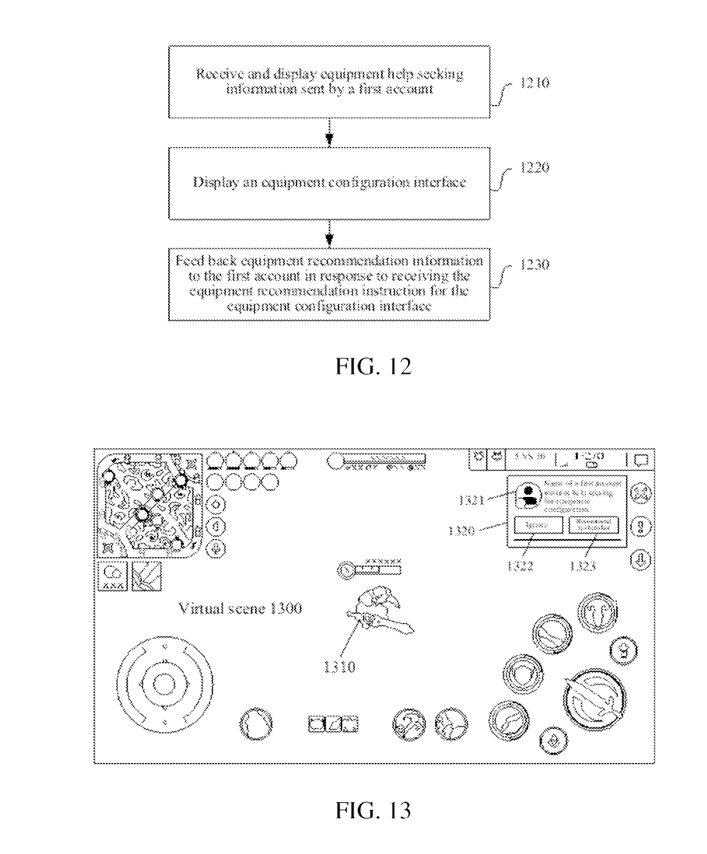

FIG. 12 is a flowchart of a method in which a second account recommends a virtual equipment to a first account according to an example of this application. The method is performed by a terminal to which the second account logs in. As shown in FIG. 12, the method includes the following operations.

Operation 1210: Receive and display equipment help seeking information sent by the first account.

The equipment help seeking information is configured for requesting a second account to provide equipment recommendation information of a first virtual character to the first account, the first virtual character is a virtual character controlled by the first account, the equipment recommendation information is configured for indicating the first account to configure a virtual equipment for the first virtual character, and the virtual equipment is configured for providing an equipment effect for the first virtual character.

In some examples, a virtual character controlled by the second account is a second virtual character. After the second account configures a virtual equipment for the second virtual character, if the equipment help seeking information sent by the first account is received, the equipment help seeking information is displayed on a display screen of the terminal to which the second account logs in.

In some examples, the equipment help seeking information includes the following information: (1) an account avatar and an account name of the first account, configured for indicating that an initiating account of the equipment help seeking information is the first account; (2) equipment help seeking information prompt text: "The first account initiates help seeking for equipment configuration", configured for indicating that the help seeking information is to request the second account to recommend a virtual equipment to the first account; (3) an ignore control: a second account player triggers the control to ignore the equipment help seeking information of the first account, and the equipment help seeking information is no longer displayed on the screen of the terminal to which the second account logs in, and the recommendation procedure ends; and (4) a recommendation control: the second account player triggering the control represents that the second account player starts to recommend the virtual equipment to the first account in response to the equipment help seeking information.

The second account may choose to accept the equipment help seeking information sent by the first account, and recommend the virtual equipment configured for the first virtual character to the first account. After the recommendation is completed, the terminal automatically feeds back the virtual equipment to the first account. Alternatively, the second account may choose to ignore the equipment help seeking information, and directly end the recommendation procedure.

For example, as shown in FIG. 13, FIG. 13 is a schematic diagram of displaying equipment help seeking information.

A second virtual character 1310 is displayed in a virtual scene 1300. An example in which a second account player has configured a virtual equipment for the second virtual character is used for description. When a first account initiates equipment help seeking to the second account, equipment help seeking information 1320 is automatically displayed. The equipment help seeking information 1320 includes an avatar identifier 1321 and a name of the first account, an ignore control 1322, and a recommendation control 1323.

In some examples, the second account player triggers the recommendation control 1323 to recommend a virtual equipment to the first account from a perspective of the first account.

Operation 1220: Display an equipment configuration interface.

The equipment configuration interface includes a plurality of candidate equipments.

When the second account recommends the equipment to the first account, a terminal to which the second account logs in directly displays an equipment configuration interface of the first account. The equipment configuration interface of the first account includes a plurality of candidate equipments and a quantity of virtual resources required for exchanging for each candidate equipment.

In some examples, types of the candidate equipments include, but are not limited to, the following types:

(1) Virtual equipment having an attack function: When the first virtual character is configured with the virtual equipment, combat power of the first virtual character can be improved in a virtual battle, and a win rate of the battle can be improved.

(2) Virtual equipment with a defense function: When the first virtual character is configured with the virtual equipment, a defense capability of the first virtual character in a virtual battle can be improved, thereby improving a win rate of the battle.

(3) Virtual equipment having a healing function: When the first virtual character is configured with the virtual equipment, if a health value of the first virtual character is less than a preset value, the health value of the first virtual character can be increased, thereby improving duration of the first virtual character in a battle.

(4) Virtual equipment having a speed improvement function: When the first virtual character is configured with the virtual equipment, a moving speed of the first virtual character and an attack/evasion speed during a virtual battle can be improved, thereby improving a win rate in the battle.

(5) Virtual equipment with a battle rebound function: When the first virtual character is configured with the virtual equipment, the first virtual character can rebound some attacks when receiving the attacks.

(6) Virtual equipment that provides a special attack manner: When the first virtual character is configured with the virtual equipment, the first virtual character can cause damage to another virtual character in the special attack manner.

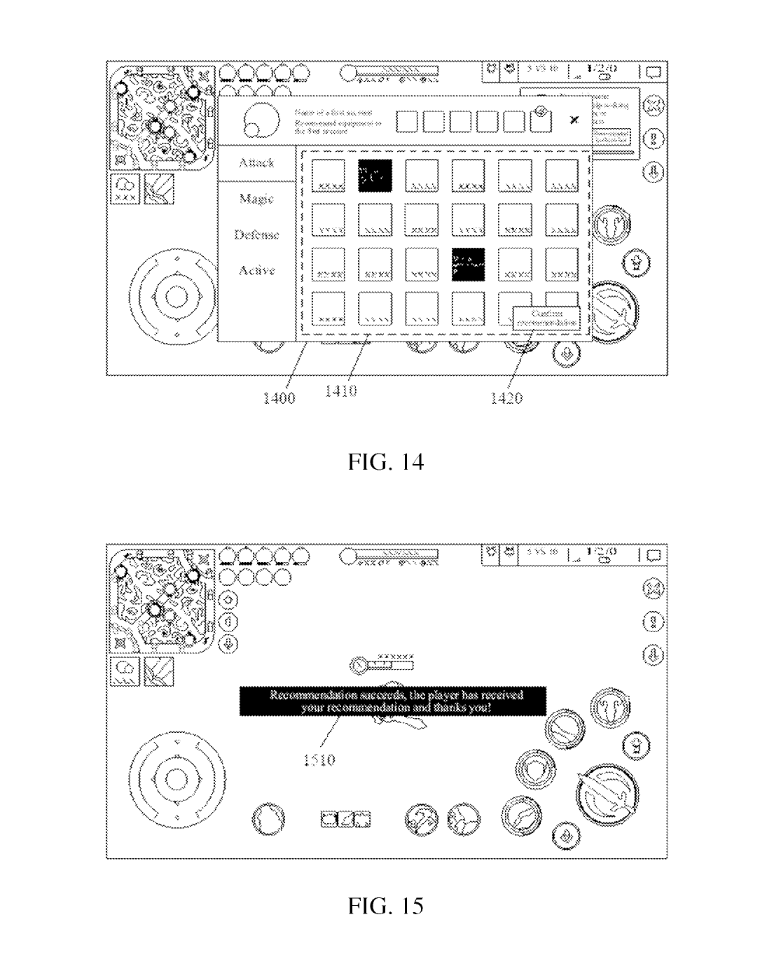

For example, referring to FIG. 14, FIG. 14 is a schematic diagram of displaying an equipment configuration interface on a terminal of a second account.

The equipment configuration interface 1400 includes a plurality of candidate equipments 1410, and the candidate equipments 1410 are classified and arranged according to functions of equipments. The equipment configuration interface 1400 further includes a name of the first account, an avatar identifier of the first account, and recommendation prompt text "Recommend equipments to the first account". The information is configured for prompting the second account that the virtual equipment is being recommended to the first account.

In some examples, a display manner of a selected virtual equipment is different from that of a virtual equipment that is not selected.

For example, as shown in FIG. 14, each candidate equipment corresponds to a preview area of the candidate equipment. A preview area color of a virtual equipment A and a virtual equipment B that are selected is black, and a preview area color of other virtual equipments that are not selected is white. There is a difference between the two.

Operation 1230: Feed back the equipment recommendation information to the first account in response to receiving an equipment recommendation instruction for the equipment configuration interface.

In some examples, the equipment configuration interface includes an equipment recommendation control, and the equipment recommendation information is fed back to the first account in response to receiving a selecting request for a first virtual equipment in the plurality of candidate equipments and a control triggering request for the equipment recommendation control, the equipment recommendation information including the first virtual equipment.

The equipment recommendation information includes a candidate equipment recommended by the second account to the first account.

As shown in FIG. 14, the equipment configuration interface 1400 further includes an equipment recommendation control 1420. After the second account player completes selecting the virtual equipment, the equipment recommendation control 1420 is triggered to complete equipment recommendation.

In other words, after a selecting request for the first virtual equipment in the equipment configuration interface is received, and the control triggering request for the equipment recommendation control in the equipment configuration interface is received, the equipment recommendation information is fed back to the first account, and the recommendation procedure ends.

After the equipment recommendation instruction is received, the terminal to which the second account logs in cancels displaying the equipment configuration interface, and displays corresponding feedback success prompt information. The feedback success prompt information is configured for prompting that the recommendation of the second account is successful, and the recommendation procedure ends.

For example, referring to FIG. 15, FIG. 15 is a schematic diagram of feeding back equipment recommendation information to a first account.

The second account feeds back the equipment recommendation information to the first account, and the terminal to which the second account logs in displays feedback success prompt information 1510: "Recommendation succeeds, the other player already receives your recommendation and thanks you!".

In some examples, the equipment help seeking information sent by the first account to the second account includes equipment information of at least two candidate equipments. In other words, the equipment help seeking information is configured for requesting the second account to recommend at least one virtual equipment to the first account from at least two candidate equipments selected by the first account.

In some examples, the equipment recommendation information is fed back to the first account in response to receiving a selecting request for a second virtual equipment in the at least two candidate equipments, the equipment recommendation information including the second virtual equipment.

According to the method provided in this application, equipment help seeking information is sent to a second account by using an equipment recommendation request, to instruct, by using the second account, how to equip a virtual equipment. Equipment recommendation information fed back by the second account based on the equipment help seeking information is displayed, so that an equipment recommended by the second account to the first account can be intuitively presented, and a player of the first account can be assisted in selecting the to-be-equipped virtual equipment. In this way, decision-making time of the player is reduced, efficiency of configuring the virtual equipment by the player and human-computer interaction efficiency are improved. In addition, a battle process of a game battle can be accelerated, thereby reducing power consumption when a device is supporting the game battle.

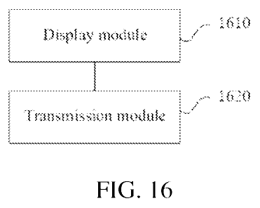

FIG. 16 is a structural block diagram of a virtual equipment recommendation apparatus according to an example of this application. As shown in FIG. 16, the apparatus includes the following parts: a display module 1610, configured to display an equipment configuration interface, the equipment configuration interface being configured for configuring a virtual equipment for a first virtual character controlled by a first account, and the equipment configuration interface including a plurality of candidate equipments; and a transmission module 1620, configured to transmit equipment help seeking information to a second account in response to receiving an equipment recommendation request, the equipment help seeking information being configured for requesting the second account to provide equipment recommendation information of the first virtual character to the first account; the display module 1610 being further configured to display the equipment recommendation information fed back by the second account, the equipment recommendation information including a candidate equipment recommended by the second account to the first account.

In an example, the equipment configuration interface includes an equipment help seeking control; and the transmission module 1620 is further configured to transmit the equipment help seeking information to the second account in response to receiving a control triggering request for the equipment help seeking control.

In an example, the transmission module 1620 is further configured to transmit the equipment help seeking information to a second account associated with the first account in response to receiving the equipment recommendation request; display an account list in response to receiving the equipment recommendation request, the account list including an associated account having an association relationship with the first account, and the associated account including the second account; and transmit the equipment help seeking information to the second account in response to receiving a selecting request for the second account; or display a candidate equipment type in response to receiving the equipment recommendation request, the candidate equipment type respectively corresponding to an equipment configuration account, and the equipment configuration account including the second account corresponding to a first equipment type; and transmit the equipment help seeking information to the second account corresponding to the first equipment type in response to receiving a selecting request for the first equipment type.

In an example, the display module 1610 is further configured to display help seeking progress information, the help seeking progress information being configured for indicating a countdown duration for which the first account is to be in an equipment help seeking process.

In an example, the transmission module 1620 is further configured to: receive a selecting request for at least two candidate equipments in the plurality of candidate equipments; and transmit the equipment help seeking information to the second account in response to receiving the equipment recommendation request, the equipment help seeking information including equipment information of the at least two candidate equipments, and the equipment help seeking information being configured for indicating the second account to perform equipment recommendation between the at least two candidate equipments.

In an example, the transmission module 1620 is further configured to: transmit the equipment help seeking information to the second account in response to receiving a selecting request for a first equipment and the equipment recommendation request, the equipment help seeking information including the first equipment, the first equipment being an equipment currently configured for the first virtual character, and the equipment help seeking information being configured for requesting the second account to recommend a virtual equipment matching the first equipment.

In an example, the display module 1610 is further configured to display an equipment chain in the equipment recommendation information in response to receiving the equipment recommendation information fed back by the second account, the equipment chain including a plurality of candidate recommended equipments, and the equipment chain being configured for indicating to exchange for the plurality of candidate recommended equipments in a chain sequence.

In an example, the display module 1610 is further configured to: when the first account accepts the equipment chain recommended by the second account, in response to a case that the first virtual character has exchanged for an n^{th} piece of candidate recommended equipment on the equipment chain and virtual resources possessed by the first virtual character are sufficient to exchange for an (n+1)^{th} candidate recommended equipment on the equipment chain, display an exchange result of the first virtual character automatically exchanging for the (n+1)^{th} candidate recommended equipment, n being a positive integer.

In an example, as shown in FIG. 17, the apparatus further includes: an exchange statistics module 1630, configured to: in response to receiving an exchange statistics request for the equipment recommendation information, display a total exchanging quantity of virtual resources needed to exchange for a candidate equipment indicated by the equipment recommendation information; receive an equipment exchange request for the candidate equipment indicated by the equipment recommendation information; display exchange success prompt information when a total quantity of virtual resources possessed by the first account is greater than or equal to the total exchanging quantity; and display the first virtual character configured with the candidate equipment indicated by the equipment recommendation information.

In an example, the plurality of candidate equipments include a first equipment; and the apparatus further includes: an equipment comparison module 1640, configured to display an equipment comparison result in response to receiving an equipment comparison request for the candidate equipment indicated by the equipment recommendation information and the first equipment, the equipment comparison result being configured for indicating a difference between the candidate equipment indicated by the equipment recommendation information and the first equipment.

In an example, the apparatus further includes: a display canceling module 1650, configured to: cancel, in response to receiving an ignoring instruction for the equipment recommendation information, displaying the equipment recommendation information.

In an example, the display module 1610 is further configured to: display, in response to receiving an equipment reference request for the second account, information about a virtual equipment configured for a second virtual character, the second virtual character being a virtual character controlled by the second account.

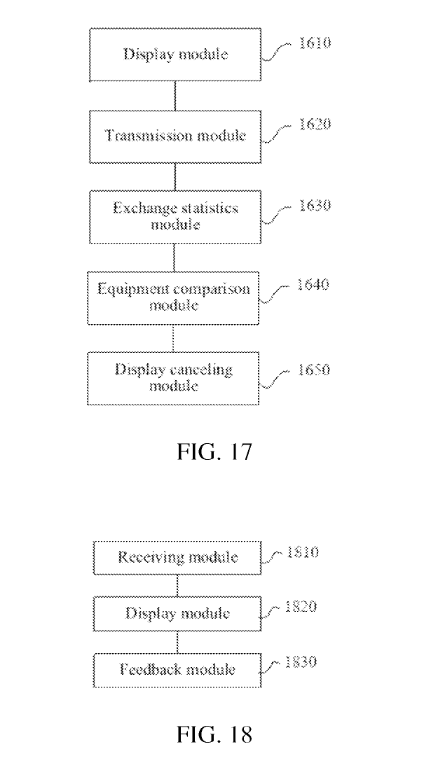

FIG. 18 is a structural block diagram of a virtual equipment recommendation apparatus according to still another example of this application. As shown in FIG. 18, the apparatus includes the following parts:

a receiving module 1810, configured to receive and display equipment help seeking information sent by a first account, the equipment help seeking information being configured for requesting a second account to provide equipment recommendation information of a first virtual character to the first account, the first virtual character being a virtual character controlled by the first account, and the equipment recommendation information being configured for indicating the first account to configure a virtual equipment for the first virtual character; a display module 1820, configured to display an equipment configuration interface, the equipment configuration interface including a plurality of candidate equipments; and a feedback module 1830, configured to feed back the equipment recommendation information to the first account in response to receiving an equipment recommendation instruction for the equipment configuration interface, the equipment recommendation information including a candidate equipment recommended by the second account to the first account.

In an example, the equipment configuration interface includes an equipment recommendation control; and the feedback module 1830 is further configured to feed back the equipment recommendation information to the first account in response to receiving a selecting request for a first virtual equipment in the plurality of candidate equipments and a control triggering request for the equipment recommendation control, the equipment recommendation information including the first virtual equipment.

In an example, the equipment help seeking information includes equipment information of at least two candidate equipments; and

the feedback module 1830 is further configured to feed back the equipment recommendation information to the first account in response to receiving a selecting request for a second virtual equipment in the at least two candidate equipments, the equipment recommendation information including the second virtual equipment.

The virtual equipment recommendation apparatus provided in the foregoing examples is merely described by using the division of the foregoing functional modules as an example. In actual application, the functions may be allocated to and completed by different functional modules according to requirements. In other words, an internal structure of the device is divided into different functional modules, to complete all or some of the functions described above. In addition, the virtual equipment recommendation apparatus provided in the foregoing examples and the virtual equipment recommendation method examples are based on the same concept. For details of a specific implementation process, refer to the method examples. Details are not described herein again.

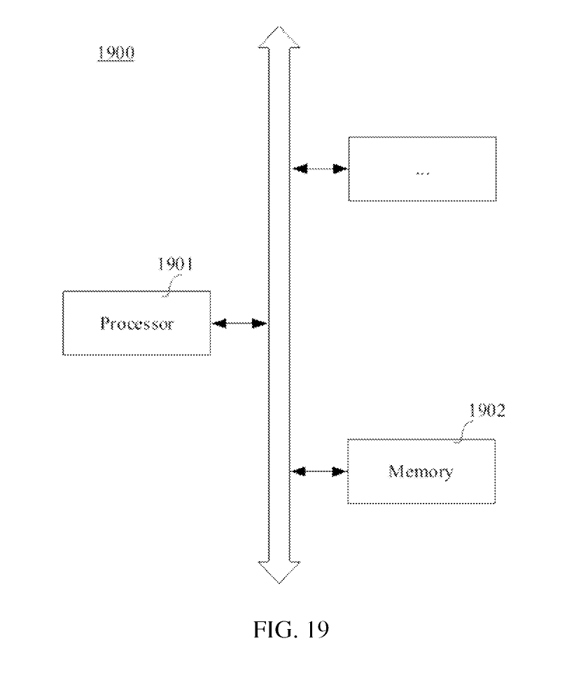

FIG. 19 is a structural block diagram of a computer device 1900 according to an example of this application. The computer device 1900 may be a smartphone, a tablet computer, a moving picture experts group audio layer III (MP3) player, a moving picture experts group audio layer IV (MP4) player, a notebook computer, or a desktop computer. The computer device 1900 may also be referred to as another name such as user equipment, a portable terminal, a laptop terminal, or a desktop terminal.

Generally, the computer device 1900 includes a processor 1901 and a memory 1902. The processor 1901 may include one or more processing cores, for example, may be a 4-core processor or an 8-core processor. In some examples, the processor 1901 may be integrated with a graphics processing unit (GPU). The GPU is configured to render and draw content that needs to be displayed on a display screen.

The memory 1902 may include one or more computer-readable storage media. The computer-readable storage medium may be non-transient. In some examples, the non-transitory computer-readable storage medium in the memory 1902 is configured to store at least one instruction. The at least one instruction is configured for being executed by the processor 1901 to implement the virtual equipment recommendation method provided in the method examples of this application.

In some examples, the computer device 1900 further includes other components. A person skilled in the art may understand that the structure shown in FIG. 19 does not constitute a limitation on the computer device 1900, and the computer device may include more or fewer components than those shown in the figure, or combine some components, or have different component deployment.

In some examples, the computer-readable storage medium may include: a read-only memory (ROM), a random access memory (RAM), a solid-state drive (SSD), an optical disc, or the like.

The sequence numbers in the foregoing examples of this application are merely for description purposes, and do not indicate the preference of the examples.

An example of this application further provides a computer device. The computer device includes a processor and a memory, the memory having at least one instruction, at least one program, a code set or an instruction set stored therein, the at least one instruction, the at least one program, the code set or the instruction set being loaded and executed by the processor to implement the virtual equipment recommendation method according to any one of the foregoing examples of this application.

An example of this application further provides a computer-readable storage medium, having at least one instruction, at least one segment of program, a code set, or an instruction set stored therein, the at least one instruction, the at least one segment of program, the code set, or the instruction set being loaded and executed by a processor to implement the virtual equipment recommendation method according to any one of the foregoing examples of this application.

This application further provides a computer program product or a computer program. The computer program product or the computer program includes computer instructions, and the computer instructions are stored in a computer-readable storage medium. A processor of a computer device reads the computer instructions from the computer-readable storage medium, and the processor executes the computer instructions, to cause the

computer device to perform the virtual equipment recommendation method according to any one of the foregoing examples.

What is claimed is:

1. A virtual equipment recommendation method, performed by a computer device, the method comprising:
displaying, on a display screen of the computer device, an equipment configuration interface, the equipment configuration interface being configured for configuring a virtual equipment for a first virtual character controlled by a first account, and the equipment configuration interface comprising a plurality of pieces of candidate equipment;
in response to receiving a control triggering request on the display, transmitting an equipment assistance request to a second account, wherein the equipment assistance request requests the second account to provide equipment recommendation information of the first virtual character to the first account; and
displaying the equipment recommendation information comprising a candidate equipment recommended by the second account to the first account.

2. The method according to claim 1, wherein the transmitting the equipment assistance request to the second account comprises:
displaying an account list in response to receiving the control triggering request, the account list comprising an associated account having an association relationship with the first account, and the associated account comprising the second account; and transmitting the equipment assistance request to the second account in response to receiving a selecting request for the second account; or
displaying a candidate equipment type in response to receiving the control triggering request, the candidate equipment type corresponding to an equipment configuration account, and the equipment configuration account comprising the second account corresponding to a first equipment type; and transmitting the equipment assistance request to the second account corresponding to the first equipment type in response to receiving a selecting request for the first equipment type.

3. The method according to claim 1, wherein before the displaying the equipment recommendation information, the method further comprises:
displaying assistance request progress information that indicates a countdown duration for which the first account is to be in an equipment assistance request process.

4. The method according to claim 1, wherein the transmitting the equipment assistance request to the second account:
receiving a selecting request for at least two pieces of candidate equipment in the plurality of pieces of candidate equipment, wherein the equipment assistance request comprises equipment information of the at least two pieces of candidate equipment, and the equipment assistance request requests the second account to perform equipment recommendation between the at least two pieces of candidate equipment.

5. The method according to claim 1, wherein the transmitting the equipment assistance request to the second account comprises:
transmitting the equipment assistance request to the second account in response to receiving a selecting request for a first equipment, the equipment assistance request comprising the first equipment, the first equipment being an equipment currently configured for the first virtual character, wherein the equipment assistance request requests the second account to recommend a virtual equipment matching the first equipment.

6. The method according to claim 1, wherein the displaying the equipment recommendation information comprises:
displaying an equipment chain in the equipment recommendation information in response to receiving the equipment recommendation information, the equipment chain comprising a plurality of pieces of candidate recommended equipment, wherein the equipment chain indicates to exchange for the plurality of pieces of candidate recommended equipment in a chain sequence.

7. The method according to claim 6, wherein after the displaying the equipment chain, the method further comprises:
when the first account accepts the equipment chain recommended by the second account, in response to the first virtual character having exchanged for an n^{th} piece of candidate recommended equipment on the equipment chain and virtual resources possessed by the first virtual character satisfying a quantity threshold to exchange for an (n+1)^{th} candidate recommended equipment on the equipment chain, displaying an exchange result of the first virtual character automatically exchanging for the (n+1)^{th} candidate recommended equipment, n being a positive integer.

8. The method according to claim 1, wherein after the displaying the equipment recommendation information, the method further comprises:
in response to receiving an exchange statistics request for the equipment recommendation information, displaying a total exchanging quantity of virtual resources needed to exchange for a candidate equipment indicated by the equipment recommendation information;
receiving an equipment exchange request for the candidate equipment indicated by the equipment recommendation information;
displaying exchange success prompt information based on a total quantity of virtual resources possessed by the first account being greater than or equal to the total exchanging quantity; and
displaying the first virtual character configured with the candidate equipment indicated by the equipment recommendation information.

9. The method according to claim 1, wherein the plurality of pieces of candidate equipment comprise a first equipment; and
after the displaying the equipment recommendation information, the method further comprises:
displaying an equipment comparison result in response to receiving an equipment comparison request for the candidate equipment indicated by the equipment recommendation information and the first equipment, the equipment comparison result indicating a difference between the candidate equipment indicated by the equipment recommendation information and the first equipment.

10. The method according to claim 1, wherein after the displaying the equipment recommendation information, the method further comprises:
canceling, in response to receiving an instruction to ignore the equipment recommendation information, displaying the equipment recommendation information.

11. The method according to claim 1, wherein the method further comprises:
displaying, in response to receiving an equipment reference request for the second account, information about a virtual equipment configured for a second virtual character, the second virtual character being a virtual character controlled by the second account.

12. A virtual equipment recommendation method, performed by a computer device, the method comprising:
receiving and displaying an equipment assistance request transmitted by a first account, wherein the equipment assistance request requests a second account to provide equipment recommendation information of a first virtual character to the first account, the first virtual character is a virtual character controlled by the first account, and the equipment recommendation information indicates the first account to configure a virtual equipment for the first virtual character;
displaying an equipment configuration interface, the equipment configuration interface comprising a plurality of pieces of candidate equipment; and
sending the equipment recommendation information to the first account in response to receiving an equipment recommendation instruction for the equipment configuration interface, the equipment recommendation information comprising a candidate equipment recommended by the second account to the first account.

13. The method according to claim 2, wherein the equipment configuration interface comprises an equipment recommendation control; and
the sending the equipment recommendation information to the first account comprises:
sending the equipment recommendation information to the first account in response to receiving a selecting request for a first virtual equipment in the plurality of pieces of candidate equipment and a control triggering request for the equipment recommendation control, the equipment recommendation information comprising the first virtual equipment.

14. The method according to claim 12, wherein the equipment assistance request comprises equipment information of at least two pieces of candidate equipment; and
the sending the equipment recommendation information to the first account comprises:
sending the equipment recommendation information to the first account in response to receiving a selecting request for a second virtual equipment in the at least two pieces of candidate equipment, the equipment recommendation information comprising the second virtual equipment.

15. A virtual equipment recommendation apparatus, comprising:
one or more processors; and
memory storing instructions that, when executed by the one or more processors, cause the virtual equipment recommendation apparatus to:
display, on a display screen of the virtual equipment recommendation apparatus, an equipment configuration interface, the equipment configuration interface being configured for configuring a virtual equipment for a first virtual character controlled by a first account, and the equipment configuration interface comprising a plurality of pieces of candidate equipment;
in response to receiving a control triggering request on the display, transmit an equipment assistance request to a second account, wherein the equipment assistance request requests the second account to provide equipment recommendation information of the first virtual character to the first account; and
display the equipment recommendation information comprising a candidate equipment recommended by the second account to the first account.

16. The virtual equipment recommendation apparatus according to claim 15, wherein the instructions, when executed by the one or more processors, cause the virtual equipment recommendation apparatus to transmit the equipment assistance request to the second account by:
display an account list in response to receiving the control triggering request, the account list comprising an associated account having an association relationship with the first account, and the associated account comprising the second account; and transmitting the equipment assistance request to the second account in response to receiving a selecting request for the second account; or
display a candidate equipment type in response to receiving the control triggering request, the candidate equipment type corresponding to an equipment configuration account, and the equipment configuration account comprising the second account corresponding to a first equipment type; and transmitting the equipment assistance request to the second account corresponding to the first equipment type in response to receiving a selecting request for the first equipment type.

17. The virtual equipment recommendation apparatus according to claim 15, wherein before displaying the equipment recommendation information, the instructions, when executed by the one or more processors, cause the virtual equipment recommendation apparatus to display assistance request progress information that indicates a countdown duration for which the first account is to be in an equipment assistance request process.

18. The virtual equipment recommendation apparatus according to claim 15, wherein the instructions, when executed by the one or more processors, cause the virtual equipment recommendation apparatus to transmit the equipment assistance request to the second account by:
receiving a selecting request for at least two pieces of candidate equipment in the plurality of pieces of candidate equipment, wherein the equipment assistance request comprises equipment information of the at least two pieces of candidate equipment, and the equipment assistance request requests the second account to perform equipment recommendation between the at least two pieces of candidate equipment.

19. The virtual equipment recommendation apparatus according to claim 15, wherein the instructions, when executed by the one or more processors, cause the virtual equipment recommendation apparatus to display the equipment recommendation information by:
displaying an equipment chain in the equipment recommendation information in response to receiving the equipment recommendation information, the equipment chain comprising a plurality of pieces of candidate recommended equipment, wherein the equipment chain indicates to exchange for the plurality of pieces of candidate recommended equipment in a chain sequence.

20. The virtual equipment recommendation apparatus according to claim 15, wherein the plurality of pieces of candidate equipment comprise a first equipment, and wherein the instructions, when executed by the one or more processors, cause the virtual equipment recommendation apparatus to:
display an equipment comparison result in response to receiving an equipment comparison request for the candidate equipment indicated by the equipment recommendation information and the first equipment, the equipment comparison result indicating a difference between the candidate equipment indicated by the equipment recommendation information and the first equipment.
